(19) United States
(12) Patent Application Publication
(10) Pub. No.: US 2006/0133371 A1
(43) Pub. Date: Jun. 22, 2006

(54) Communication data relay system and method

(75) Inventor: Kazumine Matoba, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/100,371

(22) Filed: Apr. 6, 2005

(30) Foreign Application Priority Data
Dec. 20, 2004 (JP) JP2004-367864

(51) Int. Cl. H04L 1/00; H04L 12/28; H04L 12/26; H04L 12/56

(52) U.S. Cl. 370/389; 370/229

(57) ABSTRACT

The present invention relates to a relay system that is capable of relaying communication data at high speed. There is provided a relay system that is formed by one or more servers having the same application and a client and relays communication data transmitted from the client to one of the servers, the relay system including a preceding apparatus connected to the client and a succeeding apparatus connected to the one or more servers, in which the preceding apparatus extracts predetermined data from obtained communication data, sets predetermined field data corresponding to the predetermined data in frames, and transmits the frames, and the succeeding apparatus extracts predetermined field data from frames transmitted from the preceding apparatus and determines a relay destination server corresponding to the predetermined field data from among the servers connected to the succeeding apparatus.

### BACKGROUND OF THE INVENTION

1. Field of the Present Invention

The present invention relates to a relay system that relays access from client terminals to server apparatuses.

2. Description of the Related Art

A server, such as a Web server, which provides various applications is required to instantly respond to access from multiple clients that request provision of the applications. However, there is a limitation on the number of transactions that the server is capable of processing at the same time and a response speed of the server is of course lowered when access from clients exceeds the limitation. Therefore, currently, in order to alleviate a load on a server increased by traffic concentration on the server, multiple servers having the same function are prepared and a load balancing apparatus that distributes the traffic among the servers is used among relay apparatuses that relay access from clients to servers (see FIG. 22).

As one of important functions of the load balancing apparatus, there is a persistence function. In communication between clients and servers, in order to have the servers normally perform processing with respect to access from the clients, data exchanged in a session with the same client needs to be processed by the same server at all times. Therefore, the load balancing apparatus has a function of distributing traffic for the same session to the same server at all times based on L7 information (Cookie in HTML, Secure Socket Layer-Identification (SSL-ID), or the like, for instance) that is an identifier that indicates the session in data exchanged through an application layer (hereinafter referred to as the “Layer 7 (L7)”) between a client and the server. This function is called the “persistence function”. In the following description, load distribution by the persistence function is called the “L7 load distribution”. Also, the persistence function is unnecessary for traffic that does not possess such session information. In this case, a load distribution rule other than the persistence function is used, examples of which are load distribution based on a server load condition, distribution by round robin, and the like.

In order to realize the L7 load distribution, the load balancing apparatus needs to obtain the L7 information from a reception frame. However, data exchanged between a client and a server is divided in a size, in which transmission through a network layer is possible, and is transmitted as multiple frames, so the L7 information is stored across the multiple frames and it is impossible to identify locations on the frames at which the L7 information is set. Therefore, the load balancing apparatus is incapable of obtaining the L7 information unless it searches every frame of one piece of L7 communication data. Therefore, in order to realize the L7 load distribution, a function is further required which searches all payloads of multiple frames.

In addition, when communication between a client and a server is performed using Transmission Control Protocol (TCP), TCP connection termination processing (connection state management) becomes necessary.

As described above, in order to realize the L7 load distribution, the load balancing apparatus is required to perform the high-load persistence function. In addition, the load balancing apparatus needs to perform such a high-load function with respect to a high volume of traffic from multiple clients. Consequently, there arises a problem in that the central processing unit (CPU) processing load of the load balancing apparatus is increased due to high-frequency execution of the persistence function. As a countermeasure against this problem, conventionally, an improvement in CPU performance, such as an increase of clock speed or CPU parallelization, has been achieved in the load balancing apparatus. However, the CPU performance has a limitation (around 1 gigabit per second) and there is a possibility that the load balancing apparatus itself will become a bottleneck in communication between end hosts as a result of network wider bandwidth (10 gigabit per second is at a widespread use stage).

It should be noted here that as conventional art documents relating to the present invention, it is possible to cite the following documents “JP 2003-258856 A” and “JP 2004-158977 A”.

### SUMMARY OF THE INVENTION

An object of the present invention is to provide a relay system that is capable of increasing the amount of communication data per unit time based on access from clients to server.

The present invention employs the following configurations in order to solve the described above problems. That is, the present invention relates to a relay system relaying communication data transmitted from a client when the client requests provision of an application to one of one or more servers in a network, which is formed by the one or more servers having the same application and the client and in which the communication data is exchanged between the client and the one or more servers by being divided into one or more frames, wherein the relay system includes a preceding apparatus connected to the client and a succeeding apparatus connected to the one or more servers, the preceding apparatus comprises an obtainment unit obtaining the communication data from the one or more frames transmitted from the client, an extraction unit extracting predetermined data from the obtained communication data, a determination unit determining predetermined field data corresponding to the predetermined data, and a transmission unit setting the predetermined field data in the one or more frames and transmitting the set one or more frames, and the succeeding apparatus comprises a succeeding extraction unit receiving the one or more frames transmitted from the preceding apparatus and extracting the predetermined field data from the received one or more frames, a relay destination determination unit determining a relay destination server corresponding to the extracted predetermined field data from among the one or more servers connected to the succeeding apparatus, and a transmission destination change unit changing a destination of the one or more frames received from the preceding apparatus to an address of the determined relay destination server and transmitting the changed one or more frames.

In the relay system according to the present invention, communication data divided into one or more frames and sent out from a client is relayed by the preceding apparatus and the succeeding apparatus and is sent to a server, out of one or more servers connected to the succeeding apparatus, which has been determined as a relay destination by the preceding apparatus and the succeeding apparatus.

The preceding apparatus obtains the communication data from the divided frames and extracts predetermined data from the communication data. In addition, the preceding apparatus determines predetermined field data corresponding to the predetermined data. Then, the preceding apparatus sends out the frames which are frames for transmitting the communication data and in which the predetermined field data has been set.

The succeeding apparatus receives the one or more frames sent out from the preceding apparatus and extracts predetermined field data in the frames. Then, the succeeding apparatus determines a server destination corresponding to the predetermined field data. Following this, the succeeding apparatus converts a destination of the reception frames into the determined destination and sends out the frames.

As described above, in the relay system according to the present invention, the preceding apparatus performs extraction of predetermined data from communication data, sets predetermined field data corresponding to the predetermined data in the frames, and transfers them to the succeeding apparatus. The succeeding apparatus extracts the predetermined field data from the frames and determines a relay destination server.

As a result, it becomes possible to achieve division into processing (preceding apparatus) that handles the one or more frames and extracts predetermined data from communication data obtained from the frames and processing (succeeding apparatus) that determines a relay destination server by extracting predetermined field data in the frames that are transmission units.

As a result, according to the present invention, through division into the preceding apparatus and the succeeding apparatus and a setting where it is possible to install multiple preceding functions, whose processing loads are high, in a parallel manner, it becomes possible to perform high-speed relay processing as a whole of the relay system.

Further, in the relay system according to the present invention, the determination unit determines predetermined second field data in a case where it is impossible to extract the predetermined data from the obtained communication data and the relay destination determination unit determines a relay destination server under a predetermined rule from among the one or more servers connected to the succeeding apparatus when judging that the extracted predetermined field data is the predetermined second field data.

In the present invention, even when no predetermined data exists in the communication data sent out from a client, relay processing to a server can be performed.

Further, in the relay system according to the present invention, the succeeding apparatus further includes a transfer unit that, when the received frames are not frames transmitted from the preceding apparatus, transfers the received frames to the preceding apparatus.

In the present invention, even when transmission frames from a client are directly received by the succeeding apparatus without being relayed the preceding apparatus, the transfer unit of the succeeding apparatus transfers the frames to the preceding apparatus.

As a result, according to the present invention, it becomes possible to perform relay to a server even with respect to access from a client to a server where the preceding apparatus is bypassed.

Further, in the relay system according to the present invention, when a plurality of succeeding apparatuses exist, the preceding apparatus further includes a succeeding selection unit that selects a succeeding apparatus that will serve as a transfer destination from among the plurality of succeeding apparatuses based on the predetermined data extracted by the extraction unit, and the transmission unit sets the predetermined field data in the frames, changes a destination of the frames to an address of the selected succeeding apparatus, and transmits the frames.

In the present invention, even when multiple succeeding apparatuses are installed, it is possible to appropriately relay access from clients.

Further, in the relay system according to the present invention, the preceding apparatus further includes a correspondence table holding unit that holds a correspondence table that shows correspondence between the predetermined data and the predetermined field data and is referred to by the determination unit at the time of the predetermined field data determination and a correspondence table change unit that changes contents of the correspondence table.

In the present invention, it is possible to flexibly change correspondences between predetermined data and predetermined field data for determining relay destination servers, which makes it possible to apply the present invention to networks in various forms.

It should be noted here that the present invention may be a program that realizes any of the functions described above. Also, in the present invention, the program may be recorded on a computer-readable storage medium.

According to the present invention, it becomes possible to provide a relay system that is capable of increasing the amount of communication data per unit time based on access from clients to servers.

### BRIEF DESCRIPTION OF THE DRAWINGS

FIG. 1 is a drawing showing an outline of a load balancing system in an embodiment;

FIG. 2 is a drawing showing a configuration example in the case where preceding apparatuses are installed in a server network;

FIG. 3 is a diagram showing a configuration example in the case where the preceding apparatuses are installed in a backbone network;

FIG. 4 is a diagram showing a configuration example in the case where the preceding apparatuses are installed in client networks;

FIG. 5 is a diagram showing a network configuration in a first embodiment;

FIG. 6 is a diagram showing a functional configuration of preceding apparatuses in the first embodiment;

FIG. 7 is a diagram showing a mapping rule table;

FIG. 8 is a diagram showing a functional configuration of a succeeding apparatus in the first embodiment;

FIG. 9 is a diagram showing a distribution rule table;

FIG. 10 is a diagram showing a communication sequence;

FIG. 11 is a diagram showing an operation flow of the preceding apparatuses in the first embodiment;

FIG. 12 is a diagram showing an operation flow of the succeeding apparatus in the first embodiment;

FIG. 13 is a diagram showing a network configuration in a second embodiment;

FIG. 14 is a diagram showing a functional configuration of a succeeding apparatus in the second embodiment;

FIG. 15 is a diagram showing an operation flow of the succeeding apparatus in the second embodiment;

FIG. 16 is a diagram showing a network configuration in a third embodiment;

FIG. 17 is a diagram showing a functional configuration of preceding apparatuses in the third embodiment;

FIG. 18 is a diagram showing an operation flow of the preceding apparatuses in the third embodiment;

FIG. 19 is a diagram showing a functional configuration of preceding apparatuses in a first modification;

FIG. 20 is a diagram showing a functional configuration of preceding apparatuses in a second modification;

FIG. 21 is a diagram showing a modification of the L7 distribution rule table; and

FIG. 22 is a diagram showing a conventional load balancing apparatus.

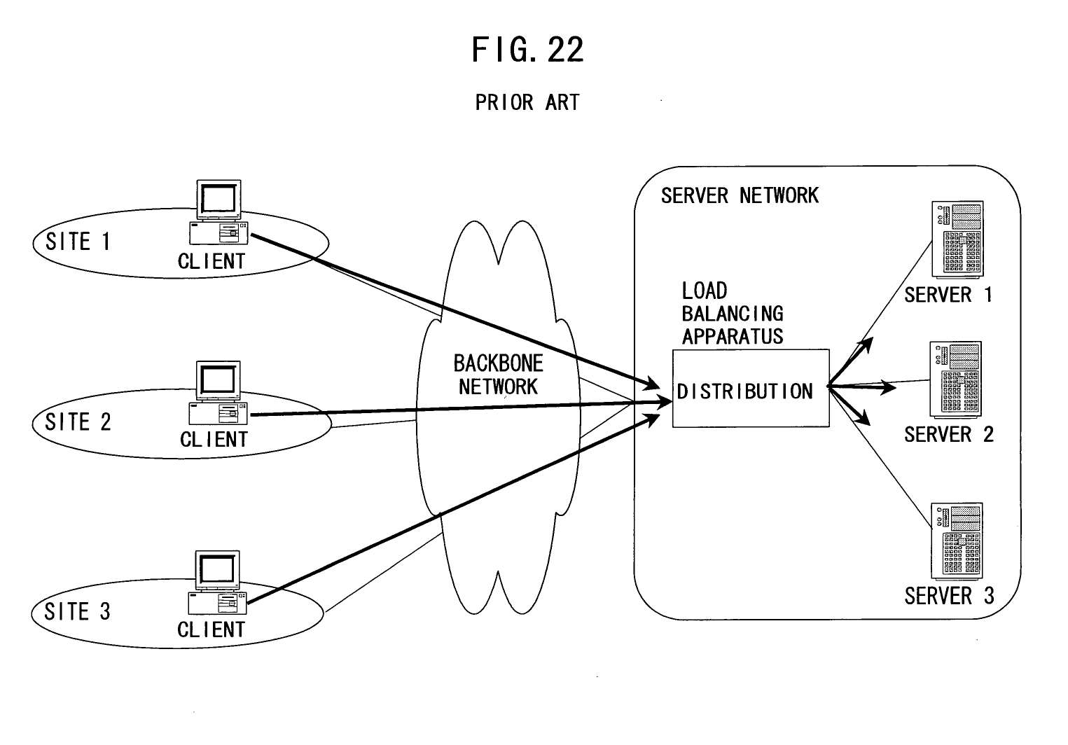

### DESCRIPTION OF THE PREFERRED EMBODIMENTS

A load balancing system according to the best mode (hereinafter referred to as the “embodiment”) of carrying out the present invention will now be described with reference to the accompanying drawings. This embodiment is an example relating to a load balancing system, out of relay systems according to the present invention, which suppresses an increase of a server load due to access from clients. Also, a configuration in this embodiment is merely an example and the present invention is not limited to the configuration in this embodiment.

[Outline of Embodiment of the Present Invention]

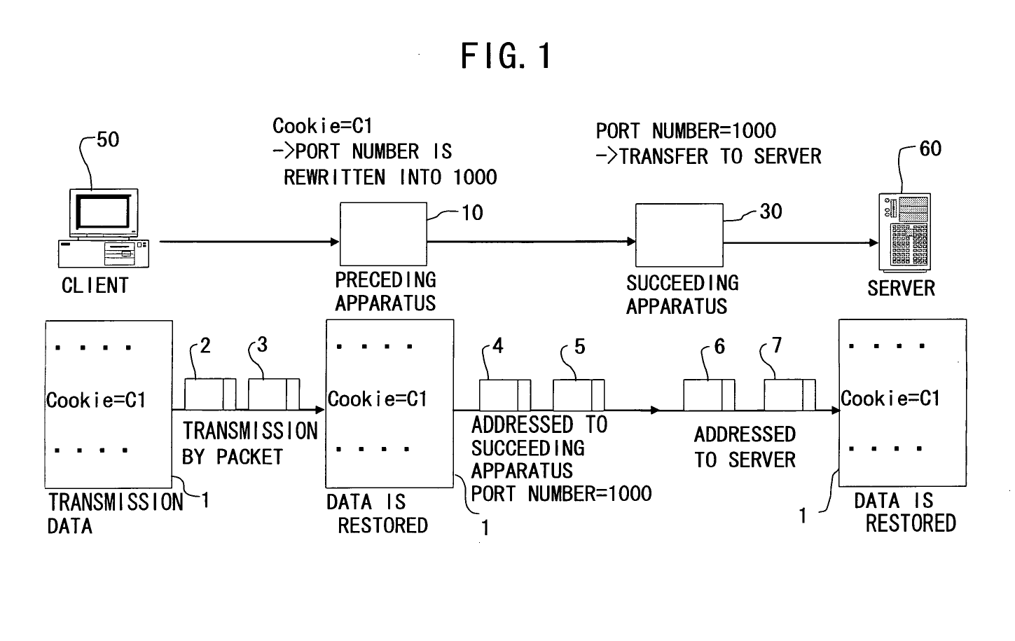

Prior to the detailed description of the embodiment of the present invention, first, the outline of the embodiment of the present invention will be described. FIG. 1 is an outline explanatory diagram of the load balancing system according to the embodiment of the present invention. In FIG. 1, the load balancing system according to the embodiment of the present invention (hereinafter referred to as the “this load-balancing system”) includes a preceding apparatus 10 and a succeeding apparatus 30. Hereinafter, functions of this load balancing system, communication data to be exchanged, and the like will be described based on an Open Systems Interconnection (OSI) hierarchical model.

In this load balancing system, a client terminal (hereinafter simply referred to as the “client”) 50 and the preceding apparatus 10 are connected to each other, the succeeding apparatus 30 is connected to a server apparatus (hereinafter simply referred to as the “server”) 60, and the preceding apparatus 10 and the succeeding apparatus 30 are connected to each other. In this manner, this load balancing system is formed. This load balancing system realizes load distribution (hereinafter referred to as the “L7 load distribution”) by a persistence function at an application layer (hereinafter referred to as the “Layer 7 (L7)”). Here, it is assumed that the server 60 provides the client 50 with various applications.

The preceding apparatus 10 extracts predetermined L7 information from multiple frames transmitted from the client 50 and transfers the frames that appends identification information corresponding to the L7 information to the succeeding apparatus 30. The succeeding apparatus 30 determines a distribution destination of the frames transferred from the preceding apparatus 10, that is, the server 60, to which a load is to be distributed, based on the identification information. Through this division into the preceding apparatus 10 and the succeeding apparatus 30, in this load balancing system, by preparing multiple preceding apparatuses 10 that perform L7 information extraction processing, the volume of traffic in charge per preceding apparatus 10, whose processing load is heavy, is reduced and only distribution processing, whose load is light, is performed at the succeeding apparatus 30 that processes a high volume of traffic.

Here, the outline of the functions described above of the preceding apparatus 10 and the succeeding apparatus 30 will be described using the example shown in FIG. 1. FIG. 1 shows an example where the client 50 and the server 60 perform communication by HyperText Transfer Protocol (HTTP) using a Cookie. Here, the Cookie is a mechanism for performing implicit information exchange between a Web server and a client and is a mechanism for temporarily storing, in response to an instruction from the web server, data in a computer that is the client accessed the Web server. In this embodiment, a case where information for identifying the server 60 is stored in the client 50 by the Cookie will be described as an example.

The client 50 transmits L7 transmission data 1 to the server 60 by HTTP. Here, a Cookie (Cookie=C1) for identifying the server 60 is inserted into the transmission data 1. Also, the transmission data 1 is divided in a size, in which transmission through the network layer is possible, and is transmitted as multiple frames (such as frames 2 and 3).

On receiving the frames 2 and 3 or the like, the preceding apparatus 10 obtains the L7 transmission data 1 by combining the frames with each other. Next, the preceding apparatus 10 obtains L7 information, such as cookie information (C1), from the transmission data 1. Then, the preceding apparatus 10 sets identification information corresponding to the L7 information in a specific field (source port field, for instance) of each frame to be transmitted to the succeeding apparatus 30 (frames 4 and 5 shown in FIG. 1). At the preceding apparatus 10, a correspondence rule between the L7 information and the identification information that should be set in the specific field is determined in advance.

The succeeding apparatus 30 confirms only the value in the specific field of each reception frame (frames 4 and 5 shown in FIG. 1) from the preceding apparatus 10 and transfers the frames 6 and 7 to the server 60 to which the frames should be distributed. That is, it becomes possible for the succeeding apparatus 30 to identify the L7 information given to the session without constructing the transmission data 1 by combining the multiple frames with each other.

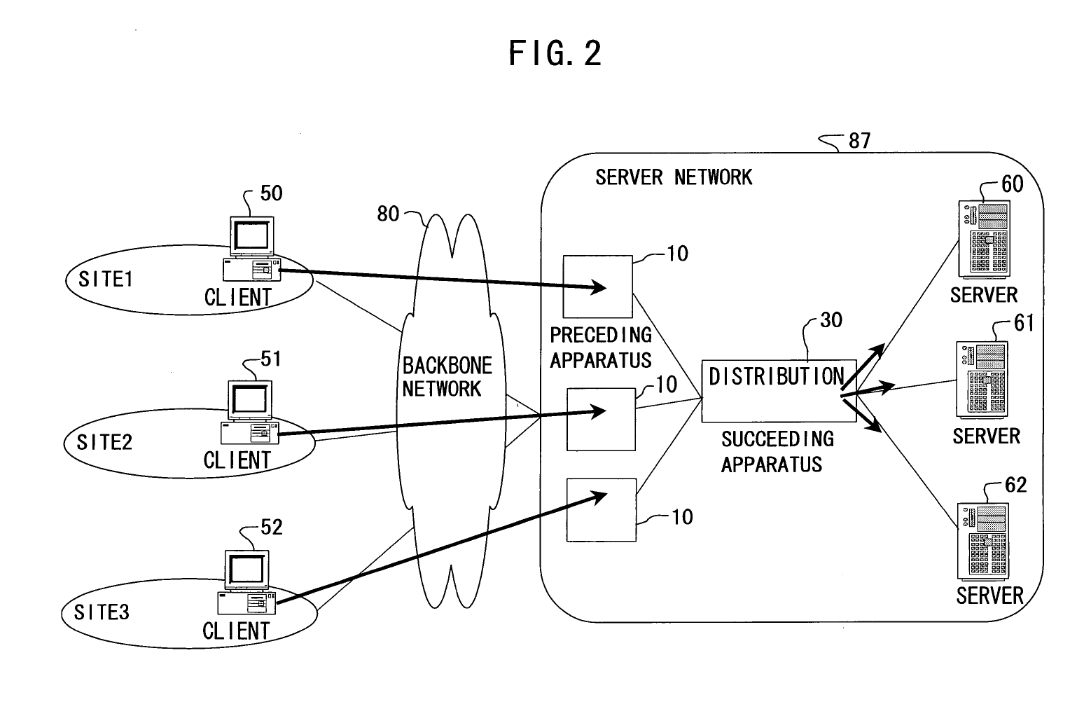

With the configuration described above, it becomes possible to arrange the preceding apparatus 10 and the succeeding apparatus 30 in this load balancing system in accordance with various network forms. FIG. 2 shows a configuration example where the preceding apparatuses are installed in a server network. In a network form shown in FIG. 2, the preceding apparatuses 10 and the succeeding apparatus 30 are installed on a network 87 where servers 60 to 62 exist. The three preceding apparatuses 10 are respectively connected to clients 50 to 52 constituting client networks through a backbone network 80. Also, the preceding apparatuses 10 are each connected to the succeeding apparatus 30 and the succeeding apparatus 30 is connected to the servers 60 to 62. With this configuration, load distribution among the servers 60 to 62 is achieved. The backbone network 80 is a trunk network for connecting networks configured at respective sites to each other.

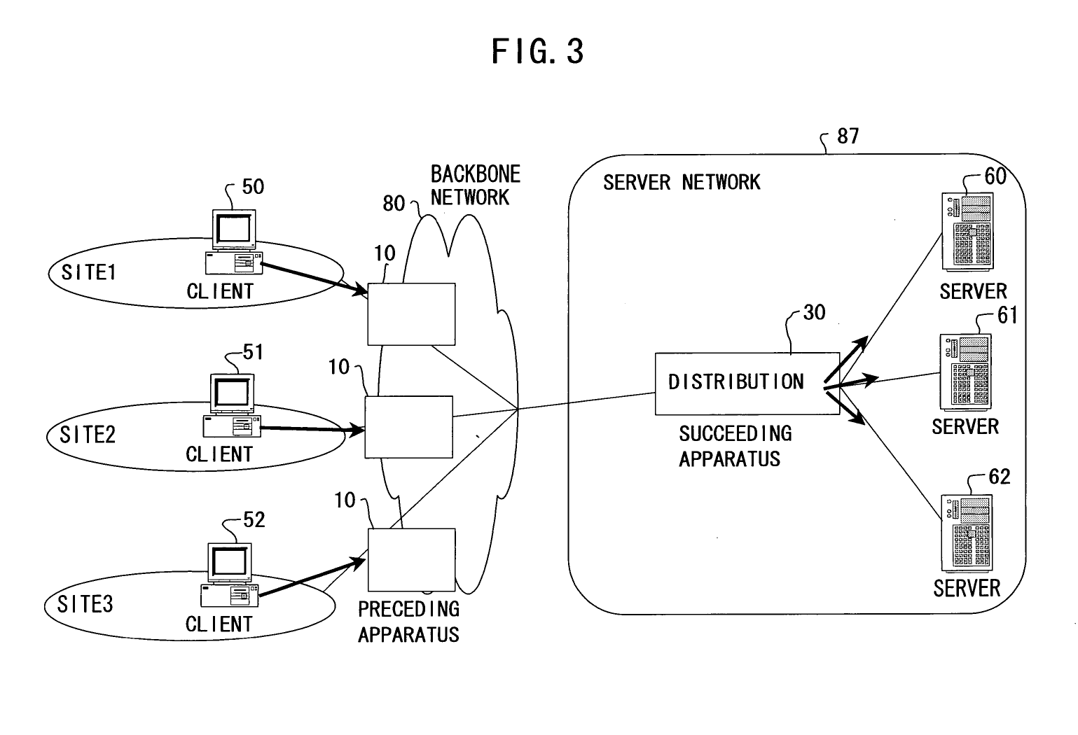

Also, FIG. 3 shows a configuration example where the preceding apparatuses are arranged in the backbone network 80. In FIG. 3, the three preceding apparatuses 10 are arranged in the backbone network 80 and are respectively connected to the clients 50 to 52. Also, the preceding apparatuses 10 are each connected to the succeeding apparatus 30 arranged in the server network 87.

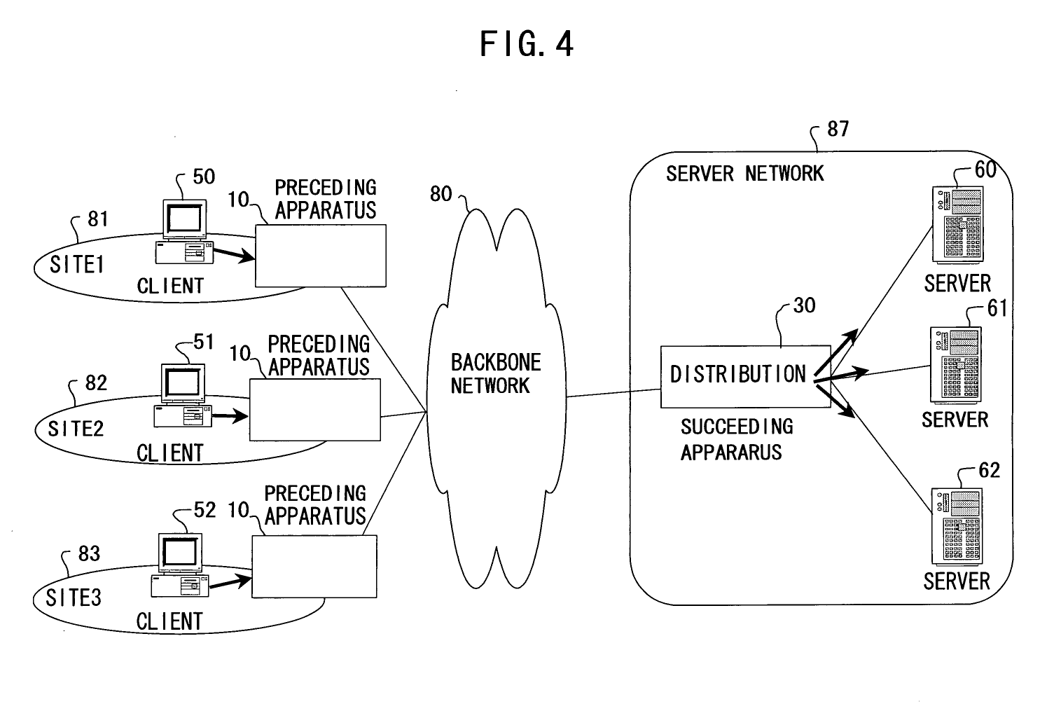

FIG. 4 shows a configuration example where the preceding apparatuses are arranged on client networks. In FIG. 4, the three preceding apparatuses 10 are respectively arranged on client networks 81 to 83 and are respectively connected to the clients 50 to 52. Also, the preceding apparatuses 10 are each connected to the succeeding apparatus 30 arranged on the server network 87 through the backbone network 80.

### First Embodiment

Hereinafter, a load balancing system in a first embodiment of the present invention will be described with reference to the drawings.

<System Configuration>

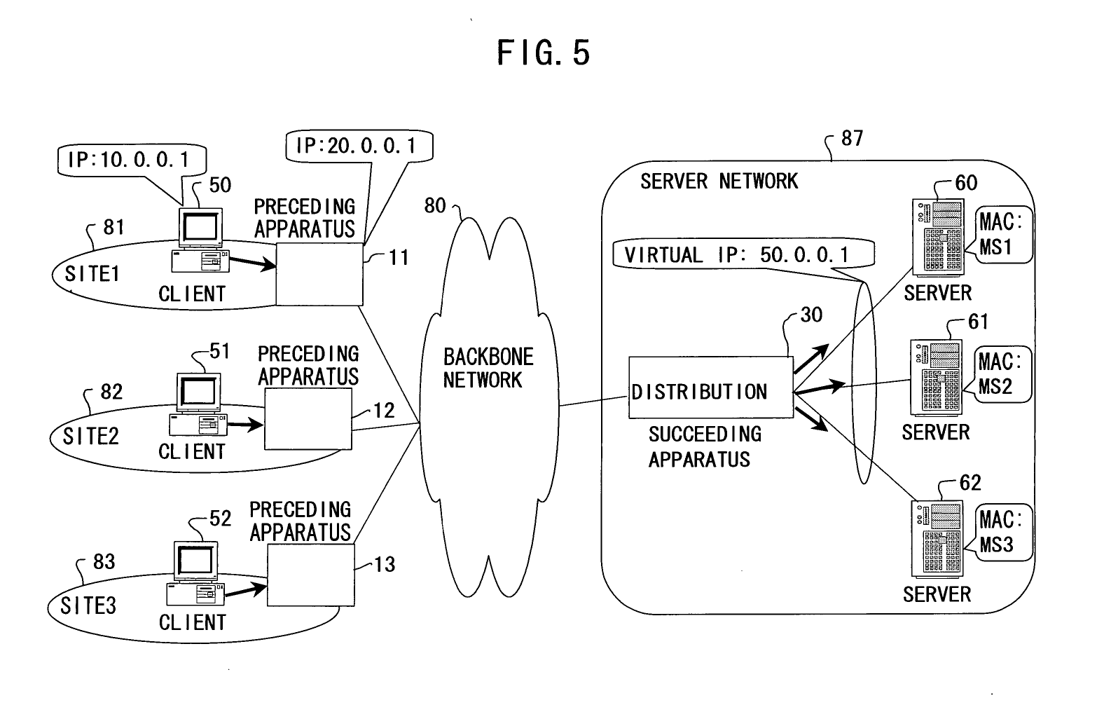

FIG. 5 shows a network configuration of the load balancing system in the first embodiment. Hereinafter, the network configuration in this embodiment will be described with reference to FIG. 5.

In the network configuration shown in FIG. 5, client networks 81 to 83 and a server network 87 are connected to each other through a backbone network 80, thereby configuring an Internet Protocol (IP) network as a whole. In the client networks 81 to 83, client terminals (hereinafter referred to as the “clients”) 50 to 52 are respectively contained. Also, in the server network 87, server terminals (hereinafter referred to as the “servers”) 60 to 62 that provide various applications are contained.

The load balancing system in the first embodiment is formed by preceding apparatuses 11 to 13 respectively arranged in the client networks 81 to 83 and a succeeding apparatus 30 arranged in the server network 87. Like in the case of the network forms shown in FIGS. 2 to 4 described above as the outline of the embodiment of the present invention, the load balancing system in the first embodiment is an example formed by three preceding apparatuses and one succeeding apparatus. The preceding apparatuses 11 to 13 are respectively connected to the clients 50 to 52 and the succeeding apparatus 30 is connected to the servers 60 to 62. Also, this load balancing system realizes load distribution among the servers 60 to 62 by means of the preceding apparatuses 11 to 13 and the succeeding apparatus 30. All of the preceding apparatuses 11 to 13 are the same apparatus, so the preceding apparatus 11 will be explained as a representative in the following description.

It should be noted here that a case will be described below in which the client 50 has an Internet Protocol Address (IP address) “10. 0. 0. 1”, the servers 60 to 62 have a virtual IP address “50. 0. 0. 1”, and the Media Access Control addresses (MAC addresses) of the servers 60 to 62 are respectively set at “MS1”, “MS2”, and “MS3”. The reason why the servers 60 to 62 have the same virtual IP address is that the servers are provided for load distribution. Therefore, the clients that access the server group recognize as one server. Accordingly, when requesting the servers 60 to 62 to provide applications, the clients 50 to 52 request with respect to the one virtual IP address “50. 0. 0. 1”.

<<Client and Server>>

The servers 60 to 62 form a server group in which load distribution is performed by the load balancing system according to the present invention. Here, it is assumed as an example that the servers 60 to 62 are each the same Web server and provide the same HTML contents. Also, the clients 50 to 52 are each a terminal that favorably receives provision of the HTML contents from the server group through load distribution among the servers 60 to 62 by the load balancing system according to the present invention.

The servers 60 to 62 and the clients 50 to 52 communicate by using the HTTP using a Cookie. The Cookie has already been described above. Here, the servers 60 to 62 transmit the HTML contents in response to access from the clients 50 to 52 by adding a Cookie where “SV1” indicating the servers 60 to 62 is set to the HTML contents. That is, a Cookie having a value “SV1” is given to L7 data exchanged between the servers 60 to 62 and the clients 50 to 52.

<<Preceding Apparatus 11>>

The preceding apparatus 11 includes, for instance, a central processing unit (CPU), a memory, an input/output interface, etc. and is one bridge apparatus having an IP communication function. However, the preceding apparatus 11 is not limited to a dedicated apparatus and may be one application that runs on a general-purpose computer having an IP communication function. The preceding apparatus 11 in the first embodiment is a bridge apparatus having the IP address “20. 0. 0. 1”.

The preceding apparatus 11 is a function of relaying data transmitted when the client 50 accesses the servers 60 to 62. Also, as described in the outline section of this specification, the preceding apparatus 11 extracts predetermined L7 information from multiple frames transmitted from the client terminal that is connected to the preceding apparatus 11, and transfers frames where identification information corresponding to the L7 information is additionally set in source port fields to the succeeding apparatus 30. In the load balancing system in the first embodiment, as the predetermined L7 information, “SV1”, “SV2”, and “SV3” possessed by cookies are used. That is, the preceding apparatus 11 converts “SV1” that is a value possessed by a Cookie and indicating the servers 60 to 62 into its corresponding identification information and sets the identification information in the frames.

Also, the preceding apparatus 11 receives frames from a server side (succeeding apparatus 30), returns the source port number rewritten in advance in the frames into an original number, and transmits resultant frames to the client 50. As described above, the preceding apparatus 11 is a function of performing heavy-load processing where multiple frames are combined with each other and L7 information is extracted.

<<Succeeding Apparatus 30>>

The succeeding apparatus 30 is one bridge apparatus having the same H/W configuration as the preceding apparatus 11. In addition, the succeeding apparatus 30 is not limited to a dedicated apparatus and may be one application that runs on a general-purpose computer having an IP communication function.

The succeeding apparatus 30 determines the distribution destination of the frames transferred from the preceding apparatus 11, that is, performs load distribution among the servers 60 to 62 based on the identification information added by the preceding apparatus 11. In more detail, the succeeding apparatus 30 receives frames from a client side (preceding apparatus 11), checks the source port fields of the frames, rewrites the destination MAC address of the frames into a distribution destination server address with reference to the identification information set in the source port fields, and transmits resultant frames. Also, on receiving frames from the servers 60 to 62, the succeeding apparatus 30 transfers the frames to the client side by performing relaying through an ordinary data link layer (hereinafter referred to as the “Layer 2 (L2)”). The succeeding apparatus 30 determines the distribution destination servers 60 to 62 by checking data at predetermined positions of frames transferred from the preceding apparatus 11, so the succeeding apparatus 30 is a function that performs processing whose load is light as compared with the processing performed by the preceding apparatus 11.

<Functional Configuration of Preceding Apparatus 11>

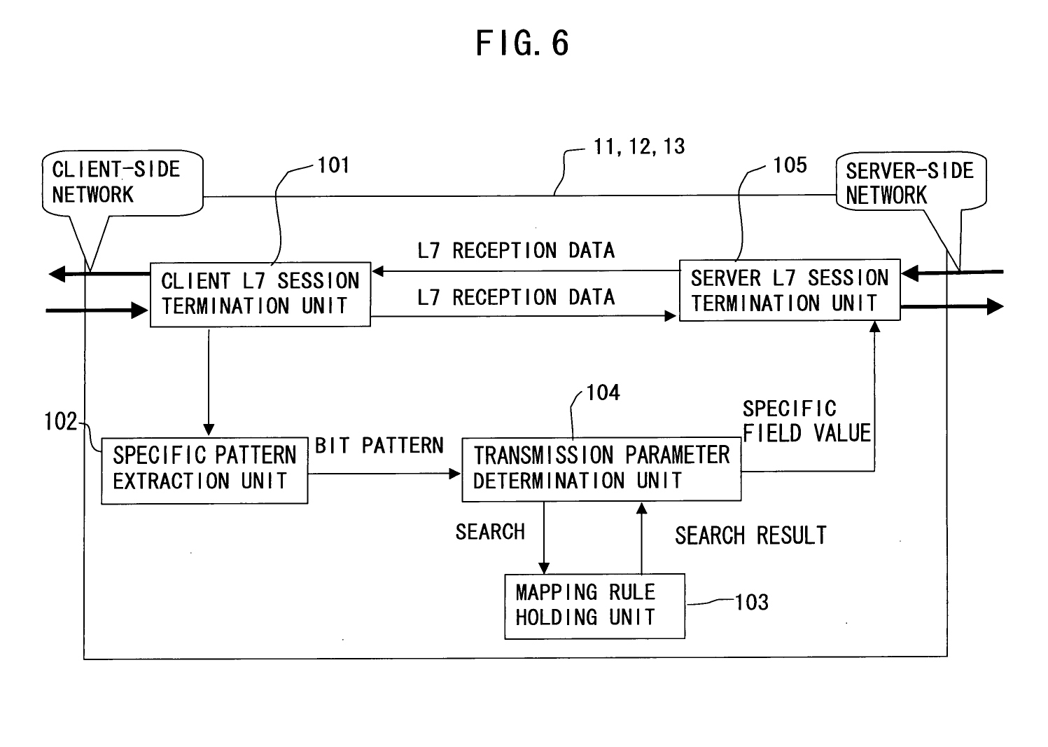

Next, functional configuration of the preceding apparatuses 11 to 13 shown in FIG. 5 will be described. FIG. 6 is a functional block diagram of the preceding apparatuses in the first embodiment shown in FIG. 5. All of the preceding apparatuses 11 to 13 shown in FIG. 5 have the same functional configuration, so the preceding apparatus 11 among them will be described as an example in the following explanation.

The preceding apparatus 11 includes a client L7 session termination unit 101 (corresponding to an obtainment unit of the present invention), a specific pattern extraction unit 102 (corresponding to an extraction unit of the present invention), a mapping rule holding unit 103 (corresponding to a correspondence table holding unit of the present invention), a transmission parameter determination unit 104 (corresponding to a determination unit of the present invention), and a server L7 session termination unit 105 (corresponding to a transmission unit of the present invention). Hereinafter, these configuration elements of the preceding apparatus 11 will be described separately.

(Client L7 Session Termination Unit 101)

The client L7 session termination unit 101 receives one or more frames transmitted from the client 50 and obtains a single piece of L7 data by combining the frames with each other. Transmission data (L7 data) at the application layer of the client 50 is divided in a size, in which transmission through the network layer is possible, and is transmitted as multiple frames, so the client L7 session termination unit 101 combines the frames with each other. Then, the client L7 session termination unit 101 informs the specific pattern extraction unit 102 and the server L7 session termination unit 105 of the obtained L7 data.

(Specific Pattern Extraction Unit 102)

The specific pattern extraction unit 102 receives the L7 data obtained by the client L7 session termination unit 101, performs matching processing under a specific rule, and extracts matching data (bit pattern). In this embodiment, the specific pattern extraction unit 102 judges whether a bit pattern “Cookie: server=“server ID”” exists in the Cookie of the L7 data and, when the bit pattern exists, extracts a bit pattern set in a portion “server ID”. Then, the specific pattern extraction unit 102 informs the transmission parameter determination unit 104 of the extracted bit pattern.

It should be noted here that when the bit pattern have not been extracted, the specific pattern extraction unit 102 informs the transmission parameter determination unit 104 that there exists no specific pattern. This case corresponds to a case where the servers 60 to 62 do not yet inform the client 50 of a Cookie and the client 50 transmits without adding the specific pattern, that is, a case where the client 50 accesses the servers 60 to 62 for the first time.

(Mapping Rule Holding Unit 103)

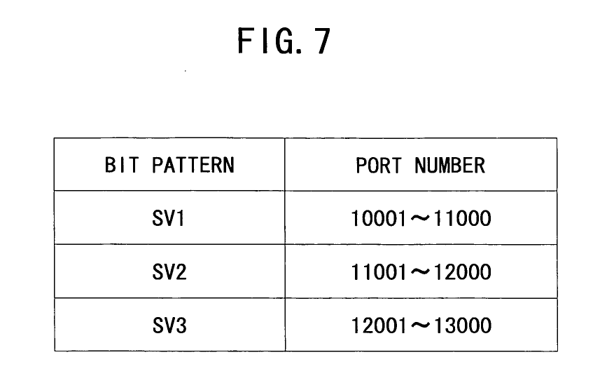

The mapping rule holding unit 103 holds the bit pattern extracted by the specific pattern extraction unit 102 and its corresponding identification information. The mapping rule holding unit 103 has a mapping rule table shown in FIG. 7. That is, the mapping rule holding unit 103 holds a correspondence table between bit patterns (SV1 shown in FIG. 7, for instance) set in the server ID portions of cookies and their corresponding port number range data.

(Transmission Parameter Determination Unit 104)

The transmission parameter determination unit 104 searches the mapping rule holding unit 103 using the bit pattern passed from the specific pattern extraction unit 102 as a key and determines a field value that should be set in frames to be transmitted to the succeeding apparatus 30. That is, the transmission parameter determination unit 104 determines a port number corresponding to the informed bit pattern. Then, the transmission parameter determination unit 104 informs the server L7 session termination unit 105 of the determined field value.

When being informed by the specific pattern extraction unit 102 that no specific pattern has been extracted, the transmission parameter determination unit 104 determines a field value (port number) indicating that there exists no specific pattern and informs the server L7 session termination unit 105 of the determined value.

(Server L7 Session Termination Unit 105)

The server L7 session termination unit 105 replaces a value in the source port fields of frames to be transferred to the succeeding apparatus 30 with the field value informed from the transmission parameter determination unit 104 and transfers resultant frames to the succeeding apparatus 30. When doing so, the server L7 session termination unit 105 holds the value in the source port fields before the replacement, the IP address of the client 50 transmitting the frames, and the field value after the replacement.

Also, when receiving frames conversely transmitted from the servers 60 to 62 to the client 50, the server L7 session termination unit 105 obtains the port number before the replacement from the held IP address of the client 50 that is a transmission source, sets the original port number in the frames, and transmits resultant frames to the client 50.

<Functional Configuration of Succeeding Apparatus 30>

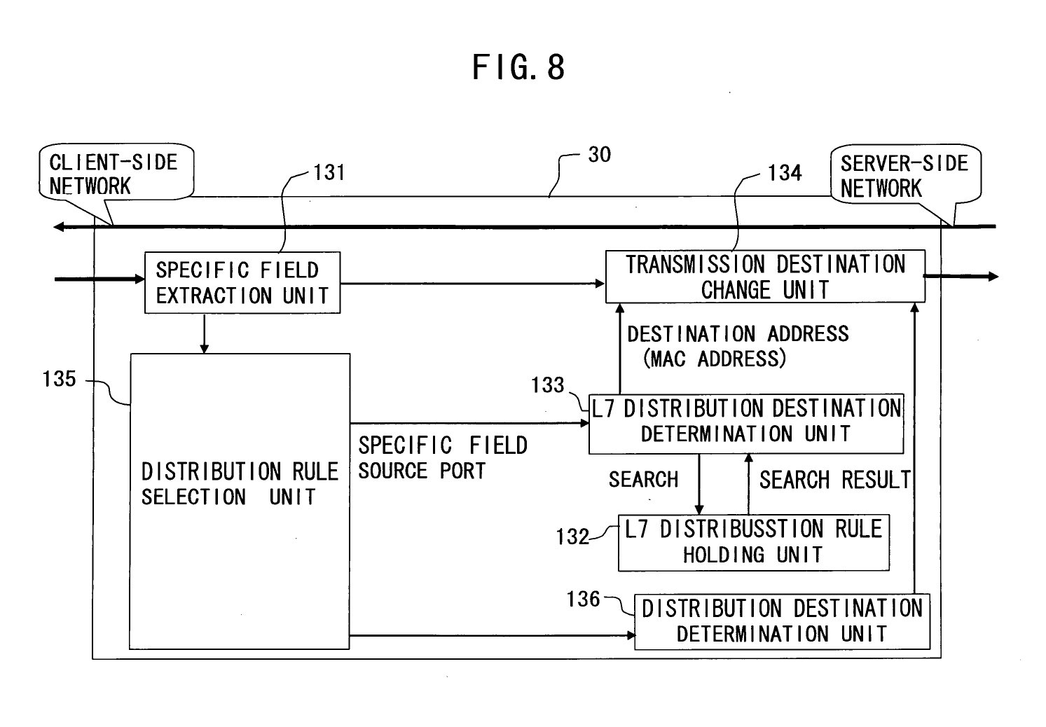

Next, a functional configuration of the succeeding apparatus 30 shown in FIG. 5 will be described. FIG. 8 is a functional block diagram of the succeeding apparatus in the first embodiment shown in FIG. 5.

The succeeding apparatus 30 includes a specific field extraction unit 131 (corresponding to a succeeding extraction unit of the present invention), an L7 distribution rule holding unit 132, an L7 distribution destination determination unit 133 (corresponding to a relay destination determination unit of the present invention), a transmission destination change unit 134 (corresponding to a transmission destination change unit of the present invention), a distribution rule selection unit 135, and a distribution destination determination unit 136. Hereinafter, these configuration elements of the succeeding apparatus 30 will be described separately.

(Specific Field Extraction Unit 131)

The specific field extraction unit 131 receives frames transferred from the preceding apparatus 11 and obtains a value at a portion (specific field) where the identification information given by the preceding apparatus 11 is set. In this embodiment, a value in the source port fields of the frames is obtained. Then, the specific field extraction unit 131 informs the distribution rule selection unit 135 of the obtained field value. Also, the specific field extraction unit 131 transfers the received frames to the transmission destination change unit 134 as they are.

(Distribution Rule Selection Unit 135)

The distribution rule selection unit 135 determines whether L7 load distribution processing is to be performed or another rule is to be used based on the value in the specific field informed from the specific field extraction unit 131. That is, when the specific field value is set at a port number indicating that no specific pattern has been extracted, new load distribution is required, so the distribution rule selection unit 135 determines that a rule other than L7 load distribution is to be used. Then, in accordance with a result of the determination, the distribution rule selection unit 135 informs the L7 distribution destination determination unit 133 of the port number that is the specific field value in the case of the L7 load distribution processing, and informs the distribution destination determination unit 136 of a port number indicating that rule other than the L7 load distribution is to be used in the case of being required to use a rule other than the L7 load distribution. The L7 load distribution processing by the succeeding apparatus means processing where based on the port number set in the specific field, reception frames are distributed among servers corresponding to the port number. On the other hand, the rule other than the L7 load distribution will be described later as a function of the distribution destination determination unit 136.

(L7 Distribution Rule Holding Unit 132)

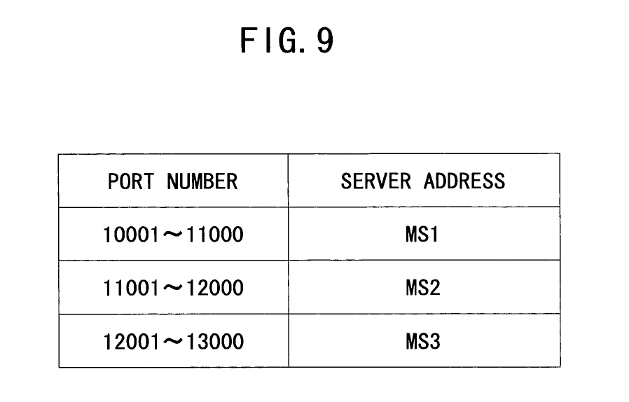

The L7 distribution rule holding unit 132 holds the port number extracted by the specific field extraction unit 131 and address information of its corresponding distribution destination servers. The L7 distribution rule holding unit 132 has a distribution rule table shown in FIG. 9. That is, the L7 distribution rule holding unit 132 holds a correspondence table between a port number added by the preceding apparatus 11 and the MAC address of its corresponding distribution destination servers.

(L7 Distribution Destination Determination Unit 133)

The L7 distribution destination determination unit 133 searches the L7 distribution rule holding unit 132 using the specific field value informed by the distribution rule selection unit 135 as a key and determines distribution destination servers. That is, the L7 distribution destination determination unit 133 determines, based on the informed port number, the MAC address of its corresponding distribution destination servers. Then, the L7 distribution destination determination unit 133 informs the transmission destination change unit 134 of the determined MAC address of the distribution destination servers.

(Distribution Destination Determination Unit 136)

When being informed by the distribution rule selection unit 135 of a port number in the case where it is required to use the rule other than the L7 load distribution, the distribution destination determination unit 136 determines distribution destination servers based on a predetermined rule. For instance, the predetermined rule is a determination method by round robin. Here, the distribution destination determination unit 136 constantly monitors the CPU loads of the respective servers 60 to 62 among which load distribution should be performed, determines one of the servers, whose load is the lightest at the determination point in time, as a distribution destination server, and informs the transmission destination change unit 134 of the MAC address of the server.

(Transmission Destination Change Unit 134)

The transmission destination change unit 134 rewrites the destination MAC address of frames to be transferred by the specific field extraction unit 131 into the MAC address of the distribution destination server informed by the L7 distribution destination determination unit 133 or the distribution destination determination unit 136 and transmits resultant frames to the determined distribution server.

<Operation Example>

Next, an operation of the load balancing system in the first embodiment will be described.

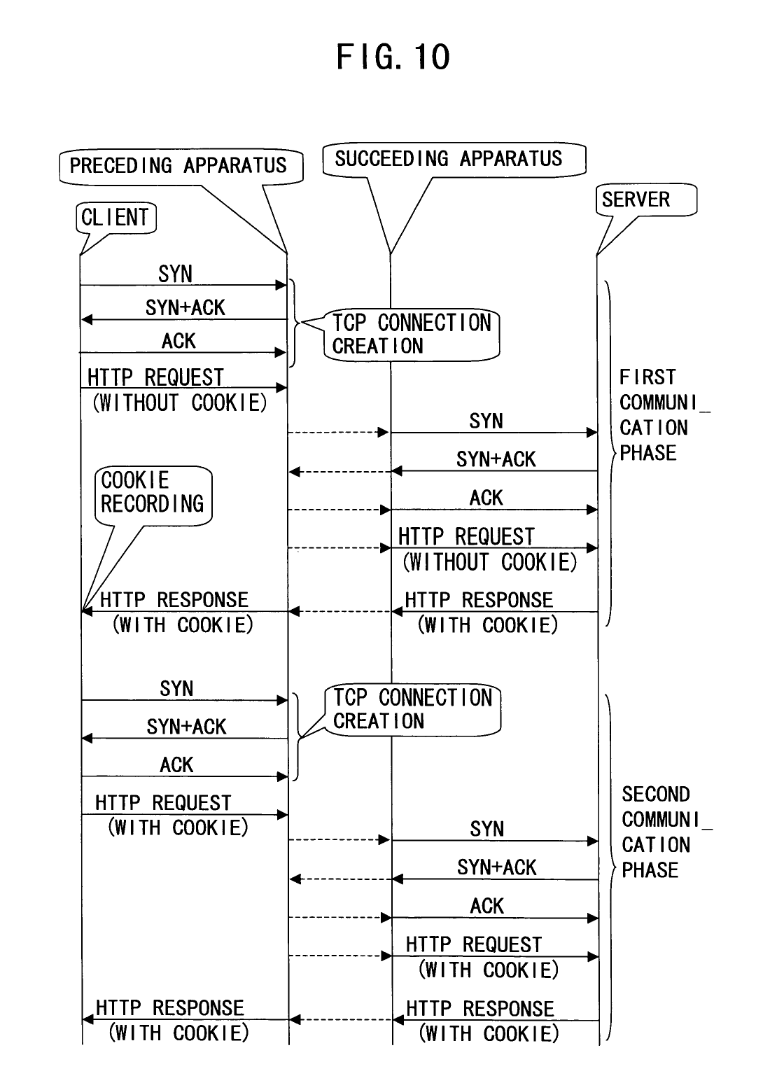

First, an operation of each configuration element described above in the network configuration shown in FIG. 5 in the case where the client 50 requests the server group 60 to 62 to provide HTML contents will be described with reference to FIG. 10. FIG. 10 shows a communication sequence in the first embodiment. The following description will be made through division into a first communication phase and a second communication phase shown in FIG. 10.

First, the first communication phase is a phase where the client 50 transmits an HTTP request containing no cookie to the server group 60 to 62 and the server group 60 to 62 returns an HTTP reply in response to the HTTP request by giving a Cookie to the HTTP reply. This is a procedure performed when the client 50 accesses the server group 60 to 62 for the first time. Also, when the servers do not support the Cookie mechanism, for instance, the first communication phase is executed in a like manner.

The second communication phase is a communication phase after a Cookie is stored in the client 50 through the first communication phase. That is, the second communication phase is a procedure where the client 50 gives the Cookie to an HTTP request and transmits the HTTP request to the server group 60 to 62 and the server gives the Cookie to an HTTP reply and returns the HTTP reply to the client 50. It should be noted here that there is also a case where the first communication phase and the second communication phase are executed in succession. In this case, it is assumed that TCP connection is temporarily cut between these phases.

<<First Communication Phase>>

The client 50 transmits an SYN packet of TCP, whose source port number is set at “4000”, to a virtual IP address “50. 0. 0. 1”. The SYN packet is generally a packet used to create TCP connection between a client and a server. The reason why the TCP connection is created in this manner is that communication between a client (Web browser) and a Web server by HTTP is performed using a virtual communication line (port) provided by a transport layer (L4).

On receiving the TCP SYN packet transmitted from the client 50, the client L7 session termination unit 101 of the preceding apparatus 11 creates TCP connection with the client 50.

Next, the client 50 transmits an HTTP request containing no cookie to the virtual IP address “50. 0. 0. 1” using the created TCP connection.

Next, on receiving all of frames transmitted from the client 50, the client L7 session termination unit 101 of the preceding apparatus 101 extracts the HTTP request (L7 data) and passes it to the server L7 session termination unit 105 along with header information of the frames. Also, the client L7 session termination unit 101 passes the HTTP request to the specific pattern extraction unit 102.

The specific pattern extraction unit 102 checks the HTTP request received from the client L7 session termination unit 11 and performs specific bit pattern matching. In this case, no cookie exists in the HTTP request, so the specific pattern extraction unit 102 informs the transmission parameter determination unit 104 that no specific pattern has been extracted.

On being informed that no specific pattern has been extracted, the transmission parameter determination unit 104 determines a port number at “15001” in this case and passes it to the server L7 session termination unit 105. The port number “15001” is a number predetermined as a number indicating that no specific pattern has been extracted.

The server L7 session termination unit 105 sets the port number “15001” informed from the transmission parameter determination unit 104 as the source port number of the TCP SYN packet and transmits the packets to the virtual IP address “50. 0. 0. 1”. When doing so, the server L7 session termination unit 105 holds a source IP address “10. 0. 0. 1” set in the TCP SYN packet, a source port number “4000” set in the packet before the replacement, and the port number “15001” after the replacement.

Next, the frames, whose source port number has been replaced by the preceding apparatus, are received by the succeeding apparatus 30. The specific field extraction unit 131 of the succeeding apparatus 30 extracts the value “15001” set in the source port fields of the received frames and informs the distribution rule selection unit 135 of the extracted value.

When confirming that the port number informed from the specific field extraction unit 131 is a number indicating that no specific pattern has been extracted, the distribution rule selection unit 135 transmits a distribution request signal to the distribution destination determination unit 136.

The distribution destination determination unit 136 determines a distribution destination server as the server 60 based on the CPU load conditions of the servers 60 to 62 and passes the MAC address “MS1” of the server 60 to the transmission destination change unit 134.

The transmission destination change unit 134 rewrites the destination MAC address of the reception frames transferred from the specific field extraction unit 131 into the address “MS1” informed from the distribution destination determination unit 136 and transfers resultant frames to a server side.

On receiving the TCP SYN frames transmitted from the succeeding apparatus 30, the server 60 returns a SYN+ACK frame as its response frame. On receiving the frame from the server 60, the succeeding apparatus 30 transfers the frame to a client side (preceding apparatus 11) as it is.

Then, on receiving the SYN+ACK frame, the server L7 session termination unit 105 of the preceding apparatus 11 returns an ACK frame to the server 60. Through this processing, TCP connection is created between the server 60 and the preceding apparatus 11.

After the TCP connection is created with the server 60, the server L7 session termination unit 105 of the preceding apparatus 11 transfers the HTTP request received from the client 50 in advance to the server 60 using the TCP connection. Processing of the succeeding apparatus 30 after reception of the HTTP request frame is the same as the processing at the time of the TCP connection creation described above, so the description thereof will be omitted.

Next, in response to the HTTP request from the client 50 to which no cookie has been given, a communication procedure is started in which an HTTP reply, with which the server 60 stores a Cookie in the client 50, is transmitted.

The server 60 transmits an HTTP reply given a Cookie having data “Cookie: server=SV1” to the preceding apparatus 11 “20. 0. 0. 1” by setting a destination port number at “15001”.

On receiving the HTTP reply frame from the server 60, the succeeding apparatus 30 transfers the frame to the client side (preceding apparatus 11) as it is.

On receiving the HTTP reply frame, the server L7 session termination unit 105 of the preceding apparatus 11 passes the HTTP replay frame and the source port number “4000” saved in advance to the client L7 session termination unit 101.

The client L7 session termination unit 101 replaces the source port number of the HTTP reply frame with the original port number “4000” and transmits the frames to the client 50 “10. 0. 0. 1”.

On receiving the HTTP reply frame, the client 50 records a Cookie “Cookie: server=SV1” in its own memory. As a result, the client 50 transmits L7 data, to which the Cookie has been implicitly given, in the following communication with the server 60.

<<Second Communication Phase>>

The second communication phase is a phase where under a state where a Cookie has been recorded, the client 50 requests the server 60 to provide HTML contents. Even in this case, like in the first communication phase, first, the client 50 transmits an SYN packet of TCP, whose source port number is set at “4001”, to the virtual IP address “50. 0. 0. 1”, thereby creating TCP connection with the client L7 session termination unit 101 of the preceding apparatus 11.

Then, the client 50 transmits an HTTP request containing a Cookie having data “Cookie: server=SV1” to the virtual server “50. 0. 0. 1” using the TCP connection.

On receiving all frames of the HTTP request, the client L7 session termination unit 101 of the preceding apparatus 11 extracts data of the HTTP request from the frames and passes the extracted data to the server L7 session termination unit 105 along with header information of the frames. Also, the client L7 session termination unit 101 passes the HTTP request to the specific pattern extraction unit 102.

The specific pattern extraction unit 102 extracts a bit pattern “SV1” relating to a server ID from the received HTTP request and passes the extracted bit pattern “SV1” to the transmission parameter determination unit 104.

The transmission parameter determination unit 104 searches the mapping rule holding unit 103 for port numbers corresponding to the bit pattern “SV1”. In this case, as shown in FIG. 7, port numbers “10001-11000” correspond to the bit pattern. Then, the transmission parameter determination unit 104 determines a port number in the range. In this embodiment, the transmission parameter determination unit 104 determines the port number at “10001” and passes it to the server L7 session termination unit 105.

The server L7 session termination unit 105 sets an SYN frame of TCP at the source port number “10001” and transmits the frame to the virtual server “50. 0. 0. 1”.

Next, the TCP SYN frame, whose source port number has been replaced by the preceding apparatus 11, is received by the succeeding apparatus 30. Then, the specific field extraction unit 131 of the succeeding apparatus 30 extracts a value set in the source port fields of the received frame. Next, the specific field extraction unit 131 passes the source port number “10001” to the distribution rule selection unit 135.

The distribution rule selection unit 135 refers to the port number informed from the specific field extraction unit 131, judges that the port number “10001” is an identification number indicating that L7 load distribution should be performed, and passes the port number “10001” to the L7 distribution destination determination unit 133.

The L7 distribution destination determination unit 133 reads the address of a distribution destination server corresponding to the port number from the L7 distribution rule holding unit 132. In this embodiment, the L7 distribution destination determination unit 133 obtains “MS1” from the table shown in FIG. 9 as the address of the distribution destination server corresponding to the port number “10001”. Then, the L7 distribution destination determination unit 133 passes the obtained address “MS1” of the distribution destination server to the transmission destination change unit 134.

The transmission destination change unit 134 rewrites the destination MAC address of the reception frame (TCP SYN frame) transferred from the specific field extraction unit 131 into the address “MS1” informed by the L7 distribution destination determination unit 133 and transfers the frame to a server side.

On receiving the TCP SYN frame, the server 60 returns a SYN+ACK frame, which is its response frame, to a client side.

On receiving the frame from the server 60, the succeeding apparatus 30 transfers it to the client side as it is. On receiving the SYN+ACK frame, the server L7 session termination unit 105 of the preceding apparatus 11 returns an ACK frame to the server 60. That is, the server L7 session termination unit 105 of the preceding apparatus 11 creates TCP connection with the server 60. Then, the server L7 session termination unit 105 of the preceding apparatus 11 transfers the HTTP request received from the client 50 in advance to the server 60 using the TCP connection.

Processing of the succeeding apparatus 30 after reception of the HTTP request frame is the same as the processing described above at the time of the TCP connection creation, so the description thereof will be omitted.

(Description of Operation Flow)

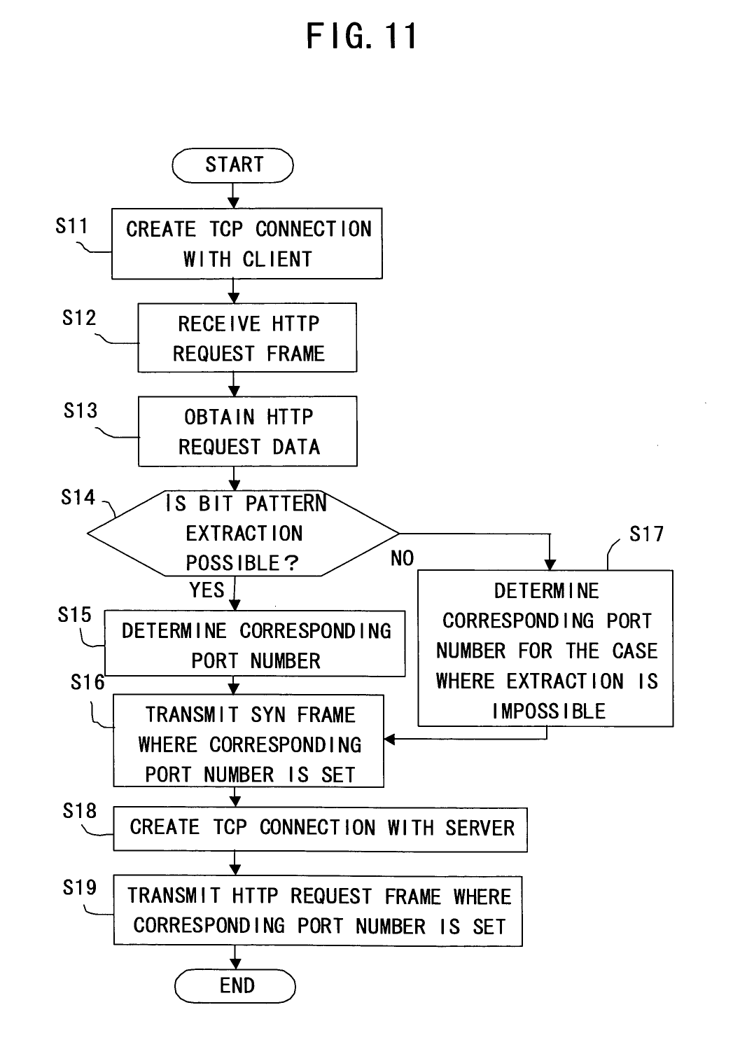

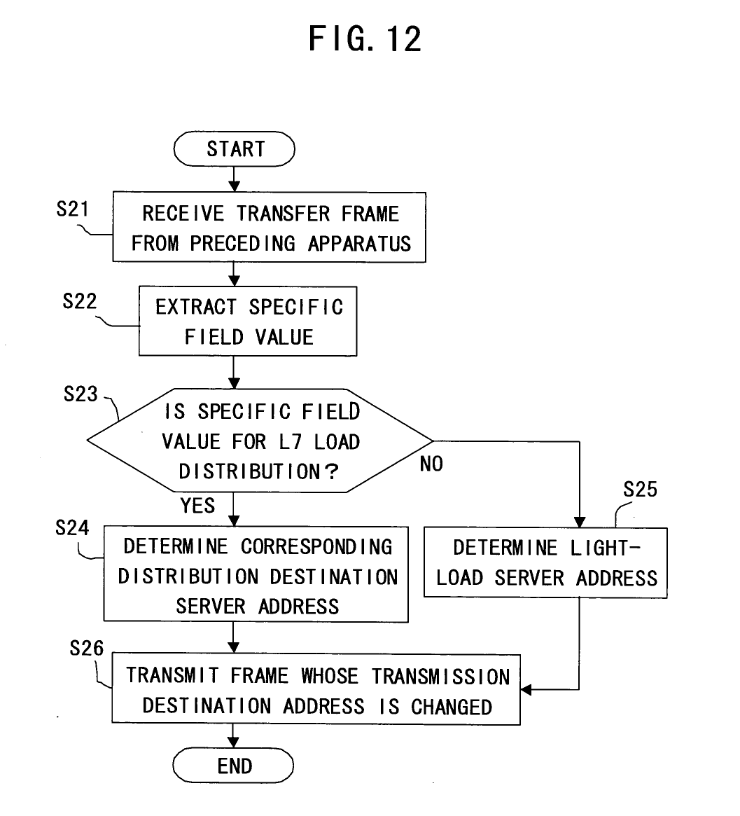

In the above description, the operation of each functional configuration of the load balancing system in the first embodiment has been explained by following the communication sequence in relation to the operations of other apparatuses. In the following description, however, the operation of each of the preceding apparatus 11 and the succeeding apparatus 30 will be explained using FIGS. 11 and 12.

((Preceding Apparatus 11))

FIG. 11 is a flowchart showing an operation of the preceding apparatus 11 in the first embodiment.

On receiving an SYN frame from the client 50, the client L7 session termination unit 101 of the preceding apparatus 11 creates TCP connection with the client 50 (S11). Next, the client L7 session termination unit 101 receives an HTTP request frame from the client 50 through the TCP connection (S12) and obtains HTTP request data from the frame (S13).

On receiving the HTTP request data, the specific pattern extraction unit 102 of the preceding apparatus tries to extract a specific bit pattern from the data (S14). Next, when the specific bit pattern (“SV1”, for instance) has been extracted (S14;YES), the transmission parameter determination unit 104 of the preceding apparatus determines a port number corresponding to the bit pattern (S15). On the other hand, when no specific bit pattern has been extracted (S14;NO), the transmission parameter determination unit 104 of the preceding apparatus determines a port number indicating that no specific pattern is extracted (S17).

Then, the server L7 session termination unit 105 of the preceding apparatus 11 sets the determined port number in the source port field of the SYN frame and transmits the frame to the succeeding apparatus 30 (S16). Through this processing, TCP connection is created between the server 60 and the server L7 session termination unit 105 of the preceding apparatus 11 (S18). Using the TCP connection, the server L7 session termination unit 105 of the preceding apparatus 11 transmits a frame, which is the HTTP request frame received in advance and whose source port number has been changed to the port number determined in the manner described above, to the succeeding apparatus 30 (S19).

((Succeeding Apparatus 30))

FIG. 12 is a flowchart showing an operation of the succeeding apparatus 30 in the first embodiment.

On receiving a frame transmitted from the preceding apparatus 11 (S21), the specific field extraction unit 131 of the succeeding apparatus 30 extracts a value in the source port field of the frame (S22). Then, the distribution rule selection unit 135 of the succeeding apparatus 30 judges whether the port number is a number for performing L7 load distribution or not (S23). Following this, when the port number is a number for performing L7 load distribution (S23;YES), the L7 distribution destination determination unit 133 determines the address of a distribution destination server corresponding to the port number based on the table of the L7 distribution rule holding unit 132 (S24). On the other hand, when the port number is a number designating a rule other than the L7 load distribution (S23;NO), the distribution destination determination unit 136 selects a server, whose CPU load has been judged as the lightest at the time, as a distribution destination server and obtains the address of the server (S25). Then, the transmission destination change unit 134 rewrites the address of frames that should be transmitted into the address of the determined distribution destination server and transmits the frames toward the servers 60 to 62 (S26).

<Operation and Effect of the First Embodiment>

In the load balancing system in the first embodiment, communication data, which is data at an application layer (L7) and has been sent out after division into one or more frames, passes through the preceding apparatuses 11 to 13 and the succeeding apparatus 30 and is sent to one of the servers 60 to 62 determined as a distribution destination by the preceding apparatuses and the succeeding apparatus.

In order to realize such server load distribution, the client L7 session termination unit 101 of the preceding apparatuses 11 to 13 receives all of the frames obtained through division and obtains L7 data from the frames. The specific pattern extraction unit 102 of the preceding apparatuses 11 to 13 extracts a specific pattern (data in a Cookie) embedded in the L7 data and indicating a transmission destination. The transmission parameter determination unit 104 of the preceding apparatuses 11 to 13 determines a port number corresponding to the specific pattern. The server L7 session termination unit 105 of the preceding apparatuses 11 to 13 sends out frames, which are frames for transmitting the L7 data and whose source port numbers have been set at the port number, to the succeeding apparatus 30.

Following this, the specific field extraction unit 131 of the succeeding apparatus 30 receives the one or more frames sent out from the preceding apparatuses 11 to 13 and extracts a value set as the source port numbers in the frames. The L7 distribution rule determination unit 133 of the succeeding apparatus 30 determines the address of a server, out of the servers 60 to 62, corresponding to the value of the source port numbers. The transmission destination change unit 134 of the succeeding apparatus 30 converts the destination addresses of the frames received by the specific field extraction unit 131 into the address and sends out resultant frames to the servers 60 to 62.

In this manner, in the load balancing system in the first embodiment, by the multiple preceding apparatuses 11 to 13, a specific pattern indicating a transmission destination is extracted from L7 data, an identification number (port number) corresponding to the specific pattern is set in frames, and the frames are transferred to the succeeding apparatus 30. At the succeeding apparatus 30, a distribution destination server is determined by checking the identification number in the frames.

With this configuration, it becomes possible to distribute heavy-load processing for dealing with one or more frames and checking a specific pattern, whose data position in the frames is variable, among the multiple preceding apparatuses 11 to 13. In addition, at the succeeding apparatus 30, it becomes possible to determine a distribution destination server by checking data at predetermined locations in frames that are a transmission unit.

That is, in the load balancing system in the first embodiment, installation of multiple preceding apparatuses on a network is made possible and high-load processing is allocated to the preceding apparatuses, so it becomes possible to perform load distribution processing at high-speed. In addition, it becomes possible to achieve an increase in the speed of the load balancing processing in a broadband network.

### Second Embodiment

Hereinafter, a load balancing system in a second embodiment of the present invention will be described with reference to the drawings.

<System Configuration>

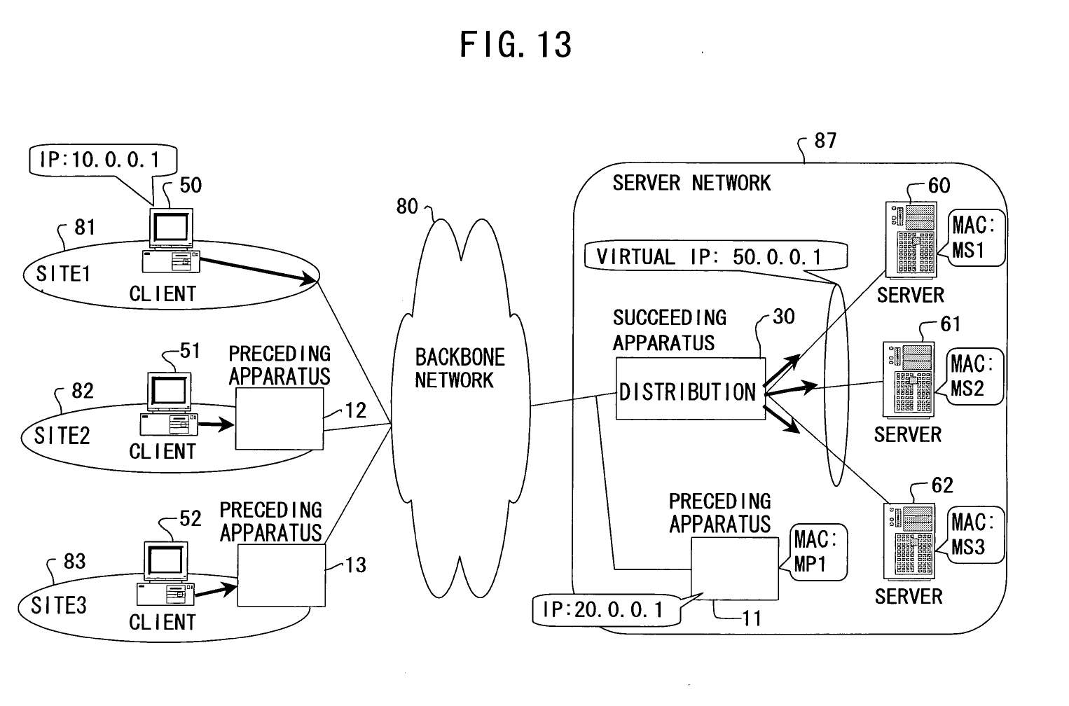

FIG. 13 shows a network configuration of the load balancing system in the second embodiment. In the network configuration in the first embodiment, as shown in FIG. 5, when the respective clients 50 to 52 access the server group 60 to 62, frames necessarily pass through the respective preceding apparatuses 11 to 13 and are transmitted to the succeeding apparatus 30, thereby realizing load distribution. In the second embodiment, however, the network configuration in the first embodiment where the preceding apparatus 11 is provided in the client network 81 is changed so that the preceding apparatus 11 is arranged in the server network 87. That is, the load balancing system in the second embodiment has a configuration with which it is possible to handle a case where in access from the client 50 to the server group 60 to 62, data is directly transmitted from the client 50 to the succeeding apparatus 30.

Hereinafter, only each functional configuration different from that in the first embodiment will be described.

<Functional Configuration of Succeeding Apparatus 30>

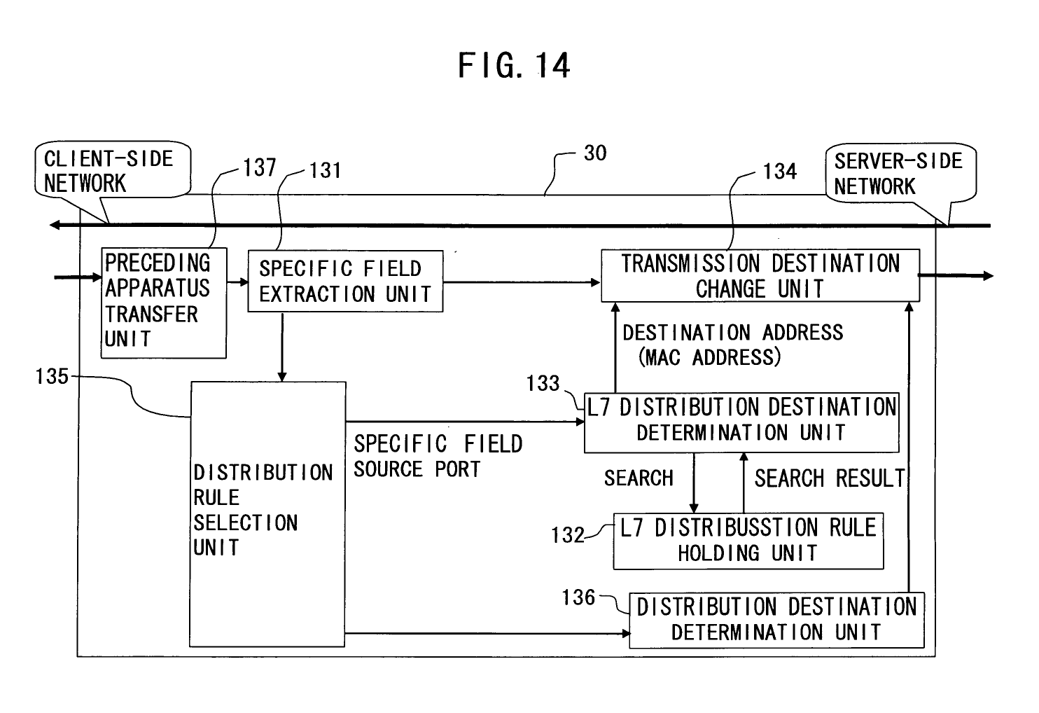

A functional configuration of the succeeding apparatus 30 shown in FIG. 13 will be described. FIG. 14 is a functional block diagram of the succeeding apparatus in the second embodiment shown in FIG. 13.

The succeeding apparatus 30 includes a preceding apparatus transfer unit 137 (corresponding to a transfer unit of the present invention) in addition to the configuration elements in the first embodiment. Each other configuration element is the same as that in the first embodiment, so the description thereof will be omitted. Hereinafter, the newly added preceding apparatus transfer unit 137 will be described.

(Preceding Apparatus Transfer Unit 137)

When reception frames are not frames transmitted from a specific source address, the preceding apparatus transfer unit 137 transfers the reception frames to the preceding apparatus 11. That is, when directly receiving frames from the client 50, the preceding apparatus transfer unit 137 transfers the frames to the preceding apparatus 11.

<Operation Example>

Next, an operation of the load balancing system in the second embodiment will be described.

Hereinafter, an operation of each configuration element described above in the case where the client 50 requests the server group 60 to 62 to provide HTML contents in the network configuration shown in FIG. 13 will be described. A communication sequence in this embodiment is the same as that in the first embodiment, so the following description will be made through division into a first communication phase and a second communication phase.

<<First Communication Phase>>

The client 50 transmits an SYN frame of TCP where a source port number is set at “4000” to the virtual server “50. 0. 0. 1”.

On receiving the TCP SYN frame, the preceding apparatus transfer unit 137 of the succeeding apparatus 30 checks the source IP address of the frame. In this case, the frame transmitted from the client 50 is directly received, so the source IP address of the frame is set at the IP address “10. 0. 0. 1” of the client 50. When judging that the source IP address is not the IP address “20. 0. 0. 1” of the preceding apparatus, the preceding apparatus transfer unit 137 rewrites the destination MAC address of the frame into “MP1” of the preceding apparatus 11 and sends the frame to a client side.

Then, the client L7 session termination unit 101 of the preceding apparatus 11 receives the transferred TCP SYN frame and then performs the same processing as in the first embodiment.

<<Second Communication Phase>>

Even in the second communication phase, the load balancing system in the second embodiment operates in the same manner as in the first communication phase. When the client 50 transmits TCP SYN packets addressed to the virtual server “50. 0. 0. 1”, the preceding apparatus transfer unit 137 of the succeeding apparatus 30 receives the frames and transfers them to the preceding apparatus 11. Then, TCP connection is created between the client L7 session termination unit 101 of the preceding apparatus 11 and the client 50. Afterwards, the same applies to an HTTP request that the client 50 transmits.

(Description of Operation Flow)

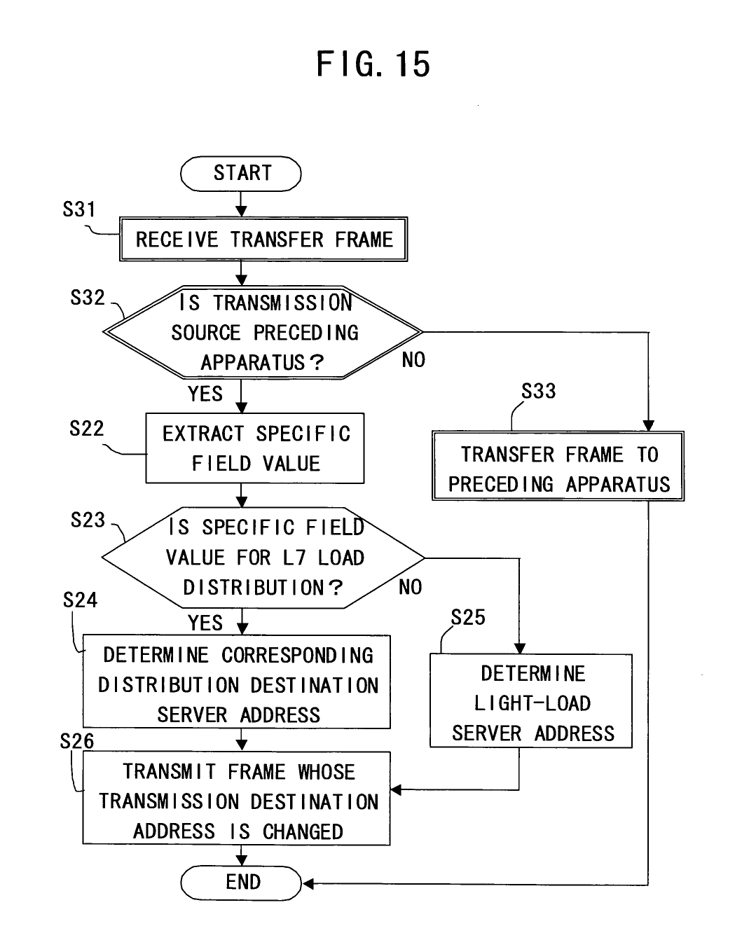

In the above description, explanation has been made in relation to the operations of other apparatuses. In the following description, however, an operation flow of the succeeding apparatus 30 in the second embodiment will be described with reference to FIG. 15. An operation flow of the preceding apparatus 11 is the same as that in the first embodiment, so the description thereof will be omitted.

((Succeeding Apparatus 30))

FIG. 15 is a flowchart showing an operation of the succeeding apparatus 30 in the second embodiment.

On receiving a frame (S31), the preceding apparatus transfer unit 137 of the succeeding apparatus 30 judges whether the transmission source of the frame is the preceding apparatus (S32). Following this, when the transmission source is the preceding apparatus (S32;YES), the following processing becomes the same as that in the first embodiment (S22 to S26). On the other hand, when the transmission source is not the preceding apparatus (S32;NO), the preceding apparatus transfer unit 137 of the succeeding apparatus 30 transfers the frame to the preceding apparatus (S33). Following this, the frame is transferred from the preceding apparatus 11 to the succeeding apparatus 30 and is processed in the same manner as in the first embodiment.

<Operation and Effect of the Second Embodiment>

In the load balancing system in the second embodiment, when the succeeding apparatus 30 directly receives a transmission frame from a client without bypassing the preceding apparatus 11, the frame is transferred to the preceding apparatus 11 by the preceding apparatus transfer unit 137 of the succeeding apparatus 30.

As a result, in the load balancing system in the second embodiment, it becomes possible to realize an L7 load distribution function also with respect to access from a network where frames do not pass through a preceding apparatus.

### Third Embodiment

Hereinafter, a load balancing system in a third embodiment of the present invention will be described with reference to the drawings.

<System Configuration>

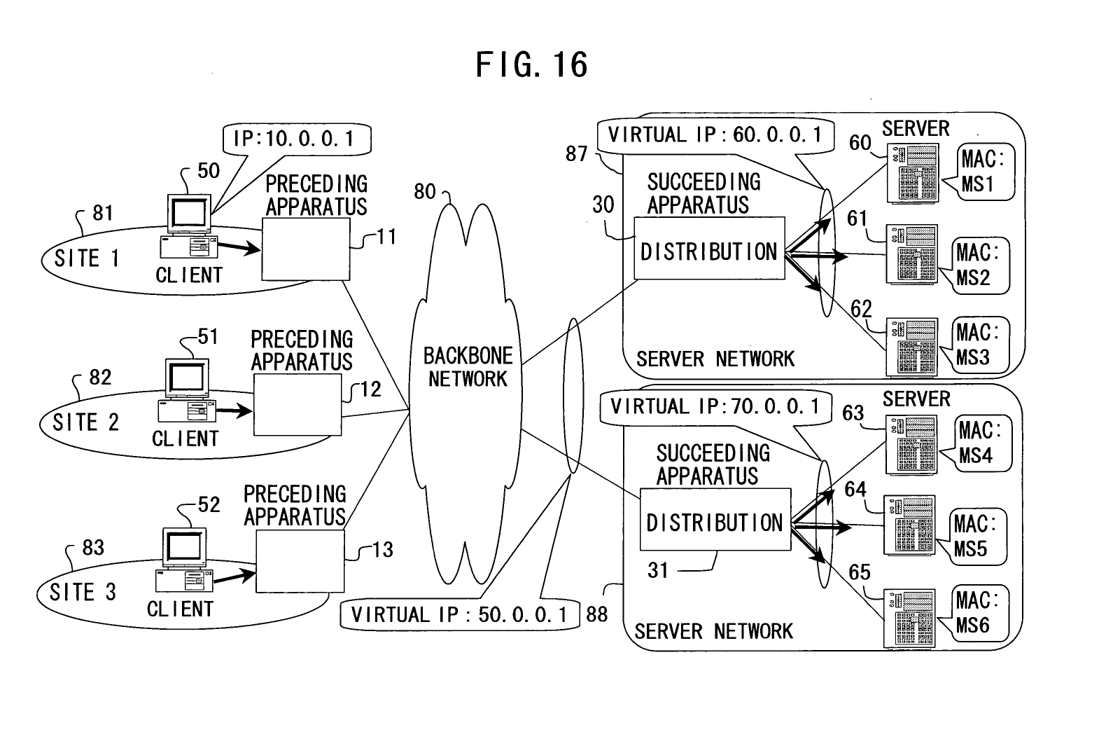

FIG. 16 shows a network configuration of the load balancing system in the third embodiment. In the network configuration in the first embodiment, as shown in FIG. 5, the server group 60 to 62 that the respective clients 50 to 52 access is arranged in the server network 87. In the third embodiment, in addition to the network configuration in the first embodiment, a server network 88 is further connected and a server group 63 to 65 is arranged in the network 88.

Also, the load balancing system in the third embodiment includes a succeeding apparatus 31, which performs load distribution in the new server group 63 to 65, in addition to the configuration in the first embodiment. That is, the load balancing system in the third embodiment has a configuration with which it is possible to handle a case where servers, among which load dispersion should be performed, are separately arranged in multiple server networks. In the network configuration in the third embodiment, a virtual IP address indicating all of the servers 60 to 65 is set at “50. 0. 0. 1”, a virtual IP address indicating the servers 60 to 62 under control by the succeeding apparatus 30 is set at “60. 0. 0. 1”, and a virtual IP address indicating the servers 63 to 65 under control by the succeeding apparatus 31 is set at “70. 0. 0. 1”.

Hereinafter, only each functional configuration different from that in the first embodiment will be described.

<Functional Configuration of Preceding Apparatus 11>

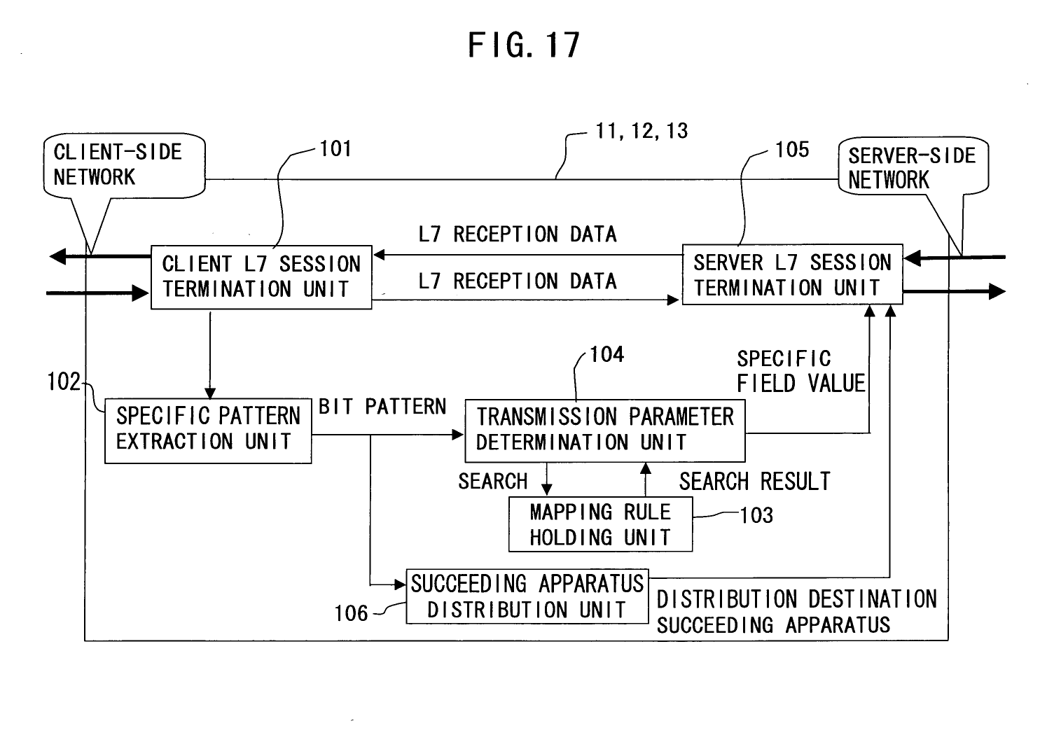

A functional configuration of the preceding apparatus 11 shown in FIG. 16 will be described. FIG. 17 is a functional block diagram of the preceding apparatus in the load balancing system in the third embodiment shown in FIG. 16.

The preceding apparatus 11 includes a succeeding apparatus distribution unit 106 (corresponding to a succeeding selection unit of the present invention) in addition to the configuration elements in the first embodiment. Each other configuration element is the same as that in the first embodiment, so the description thereof will be omitted. Hereinafter, only each configuration different from that in the first embodiment will be described. Also, the succeeding apparatuses 30 and 31 are the same apparatus, so the succeeding apparatus 30 will be explained as a representative in the following description.

(Specific Pattern Extraction Unit 102)

The specific pattern extraction unit 102 informs the succeeding apparatus distribution unit 106 as well as the transmission parameter determination unit 104 of an extracted bit pattern. Even when it is impossible to extract a bit pattern, the specific pattern extraction unit 102 informs the succeeding apparatus distribution unit 106 and the transmission parameter determination unit 104 that no specific pattern exists.

(Succeeding Apparatus Distribution Unit 106)

The succeeding apparatus distribution unit 106 selects a transfer destination succeeding apparatus from among the multiple succeeding apparatuses based on a bit pattern passed from the specific pattern extraction unit 102. Then, the succeeding apparatus distribution unit 106 passes a virtual IP address corresponding to the selected succeeding apparatus to the server L7 session termination unit 105. In this embodiment, when the bit pattern is “SV1”, “SV2”, or “SV3”, the succeeding apparatus distribution unit 106 passes the virtual IP address “60. 0. 0. 1” of the succeeding apparatus 30. Also, when the bit pattern is “SV4”, “SV5”, or “SV6”, the succeeding apparatus distribution unit 106 passes the virtual IP address “70. 0. 0. 1” of the succeeding apparatus 31.

Also, when being informed by the specific pattern extraction unit 102 that no specific pattern exists, the succeeding apparatus distribution unit 106 selects a transfer destination succeeding apparatus using another rule (round robin, for instance) and passes the address of the selected succeeding apparatus to the server L7 session termination unit 105.

(Server L7 Session Termination Unit 105)

The server L7 session termination unit 105 replaces a value in the source port fields of frames to be transferred with a field value informed from the transmission parameter determination unit 104. In addition, the server L7 session termination unit 105 rewrites a transmission destination address in the frames to be transferred into the virtual IP address of the transfer destination succeeding apparatus informed from the succeeding apparatus distribution unit 106. Then, the server L7 session termination unit 105 transfers the frames to the succeeding apparatus.

<Operation Example>

Next, an operation of the load balancing system in the third embodiment will be described.

Hereinafter, an operation of each configuration element described above in the network configuration shown in FIG. 16 in the case where the client 50 requests the server group 60 to 62 to provide HTML contents will be described. A communication sequence in this embodiment is the same as that in the first embodiment, so the following description will be made through division into a first communication phase and a second communication phase.

<<First Communication Procedure>>

Processing where the client L7 session termination unit 101 of the preceding apparatus 11 extracts an HTTP request transmitted from the client 50 from a reception frame and passes the HTTP request to the specific pattern extraction unit 102 is the same as that in the first embodiment.

The specific pattern extraction unit 102 checks the HTTP request received from the client L7 session termination unit 101. In this case, no cookie exists, so the specific pattern extraction unit 102 informs the transmission parameter determination unit 104 and the succeeding apparatus distribution unit 106 that no bit pattern has been extracted.

On being informed that no specific pattern has been extracted, the succeeding apparatus distribution unit 106 selects one of the succeeding apparatus 30 and the succeeding apparatus 31 by round robin or the like. Then, the succeeding apparatus distribution unit 106 passes the virtual IP address “60. 0. 0. 1” of the selected succeeding apparatus 30 to the server L7 session termination unit 105.

The transmission parameter determination unit 104 passes the port number “15001” to the server L7 session termination unit 105 like in the first embodiment.

The server L7 session termination unit 105 replaces the source port number of a TCP SYN packet with the port number “15001” informed from the transmission parameter determination unit 104, replaces the destination IP address of the TCP SYN packet with the virtual IP address “60. 0. 0. 1” informed from the succeeding apparatus distribution unit 106, and transmits the packets. When doing so, the server L7 session termination unit 105 holds a source IP address “10. 0. 0. 1” originally set in the TCP SYN packet, the source port number “4000” set in the packet before the replacement, and the port number “15001” after the replacement. Through this processing, a situation is obtained in which the succeeding apparatus 30 having the virtual IP address determined by the succeeding apparatus distribution unit 106 receives the frame. The subsequent operation is the same as that in the first embodiment.

<<Second Communication Procedure>>

The second communication procedure is a phase where the client 50 requests the server 60 to provide HTML contents under a state where a Cookie is recorded. Even in this case, processing where the client L7 session termination unit 101 of the preceding apparatus 11 extracts an HTTP request transmitted from the client 50 from a reception frame and passes the HTTP request to the specific pattern extraction unit 102 is the same as that in the first embodiment.

The specific pattern extraction unit 102 extracts a bit pattern “SV1” relating to a server ID from the received HTTP request and passes the extracted bit pattern “SV1” to the transmission parameter determination unit 104 and the succeeding apparatus distribution unit 106.

On being informed of the bit pattern “SV1”, the succeeding apparatus distribution unit 106 determines the virtual IP address “60. 0. 0. 1” of the succeeding apparatus 30 corresponding to the bit pattern “SV1”. Then, the succeeding apparatus distribution unit 106 passes the virtual IP address “60. 0. 0. 1” of the succeeding apparatus 30 to the server L7 session termination unit 105.

The transmission parameter determination unit 104 passes a port number “10001” corresponding to the bit pattern “SV1” to the server L7 session termination unit 105 like in the first embodiment.

The server L7 session termination unit 105 sets the source port field of an SYN frame of TCP at “10001” informed by the transmission parameter determination unit 104. In addition, the server L7 session termination unit 105 sets the destination IP address of the TCP SYN frame at “60. 0. 0. 1” informed by the succeeding apparatus distribution unit 106. Then, the server L7 session termination unit 105 transmits the frames. Following this, the succeeding apparatus 30 having the virtual IP address determined by the succeeding apparatus distribution unit 106 receives the frame. The subsequent operation is the same as that in the first embodiment.

(Description of Operation Flow)

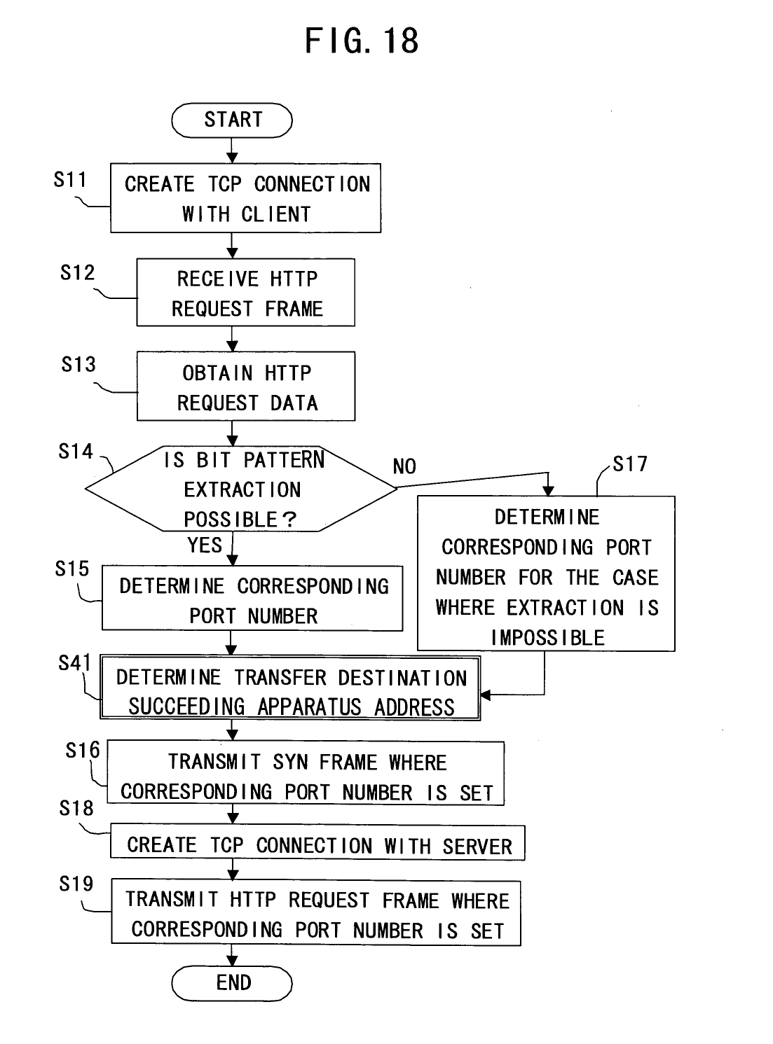

In the above description, explanation has been made in relation to the operations of other apparatuses. In the following description, however, an operation flow of the preceding apparatus 11 in the third embodiment will be described with reference to FIG. 18. An operation flow of the succeeding apparatus 30 in the third embodiment is the same as that in the first embodiment, so the description thereof will be omitted.

((Preceding Apparatus 11))

FIG. 18 is a flowchart showing an operation of the preceding apparatus 11 in the third embodiment.

An operation flow where the preceding apparatus 11 receives an SYN frame from the client 50 and extracts a port number is the same as that in the first embodiment (S11 to S15 and S17). In addition to the port number extraction, the succeeding apparatus distribution unit 106 determines a transfer destination succeeding apparatus based on a bit pattern passed from the specific pattern extraction unit 102 and obtains the address of the succeeding apparatus (S41). Then, the server L7 session termination unit 105 transfers a frame, in whose source port field a determined port number is set, to the determined succeeding apparatus (S16, S18, and S19). A subsequent operation flow is the same as that in the first embodiment.

<Operation and Effect of the Third Embodiment>

In the load balancing system in the third embodiment, the succeeding apparatus distribution unit 106 of the preceding apparatuses 11 to 13 selects one of the succeeding apparatuses 30 to 31, to which frames should be transferred, based on pattern data extracted by the specific pattern extraction unit 102. Following this, a source port number is rewritten into a port number determined by the transmission parameter determination unit 104 and the frames is sent out to the determined succeeding apparatus by the server L7 session termination unit 105 of the preceding apparatuses 11 to 13.

Accordingly, even when servers, among which load distribution should be performed, exist on different networks, it becomes possible to distribute frames from a client with respect to multiple succeeding apparatuses installed on the networks.

[First Modification]

In the embodiments of the present invention, a mapping rule between a bit pattern (“SV1”, for instance) extracted by the specific pattern extraction unit 102 and a specific field value (port number, for instance) to be given to frames is recorded in the mapping rule holding unit 103 in advance (mapping rule table shown in FIG. 7, for instance).

<Functional Configuration in the First Modification>

In a load balancing system in the first modification, a configuration is used with which it is possible to dynamically change the mapping rule. That is, in the load balancing system in the first modification, a mapping rule change unit 107 (corresponding to a correspondence table change unit of the present invention) is newly included in the preceding apparatuses. Other configurations are all the same as those in the embodiments described above.

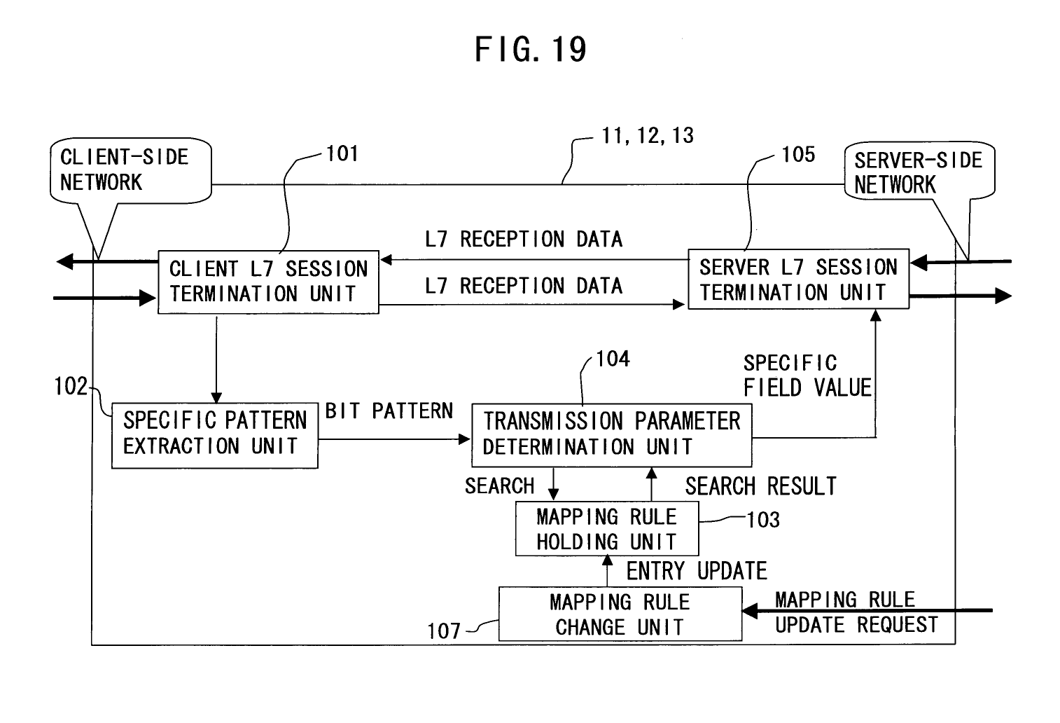

FIG. 19 shows a functional configuration of the preceding apparatuses in the first modification.

The mapping rule change unit 107 receives a bit pattern and specific field value update request from another terminal or the succeeding apparatus and changes the contents of the mapping rule holding unit 103 based on the received request. Following this, the transmission parameter determination unit 104 determines a specific field value (port number) based on the updated information in the mapping rule holding unit 103.

<Operation Example in the First Modification>

An operation of the load balancing system in the first modification in the case where the port number range corresponding to “SV3” is changed to “20001 to 30000” in the mapping rule table shown in FIG. 7 of the embodiments described above will be described.

A terminal outside the system transmits a frame, in which data indicating a new mapping rule “port numbers corresponding to the bit pattern “SV3” are “20001 to 30000”” is set, to each of the preceding apparatuses 11 to 13. Note that a function of transmitting such a frame may be implemented in the preceding apparatuses or the succeeding apparatus instead of the terminal outside the system.

On receiving the frame, the mapping rule change unit 107 of the preceding apparatuses 11 to 13 searches the mapping rule holding unit 103 for an entry for the bit pattern “SV3”. Then, the mapping rule change unit 107 rewrites data indicating port numbers “12001 to 13000” obtained as a result of the search into “20001 to 30000”.

Data in the mapping rule holding unit 103 is rewritten through the operation described above, so the transmission parameter determination unit 104 selects a source port number from among “20001 to 30000” for each frame whose extracted bit pattern is “SV3”.

<Operation and Effect of the First Modification>

In the load balancing system in the first modification, the mapping rule in the mapping rule holding unit 103, which the transmission parameter determination unit 104 refers to for port number determination, is changed by the mapping rule change unit 107 of the preceding apparatuses 11 to 13.

As a result, it becomes possible to flexibly determine a specific field value (port number) for identifying a distribution destination server. Also, it becomes possible to apply this load balancing system to networks in various forms such as a network where it is inevitably required to change a predetermined port number.

[Second Modification]

In the embodiments of the present invention, a matching rule that the specific pattern extraction unit 102 uses in order to extract a bit pattern is prepared in advance. For instance, the specific pattern extraction unit 102 extracts a bit pattern set in a “server ID” portion by performing matching of L7 data with a bit pattern “Cookie: server=“server ID””.

<Functional Configuration in the Second Modification>

In a load balancing system in the second modification, a configuration is used with which it is possible to dynamically change the matching rule described above. In the load balancing system in the second modification, a matching rule change unit 108 and a matching rule holding unit 109 are newly added to the preceding apparatuses. Other configurations are all the same as those in the embodiments described above.

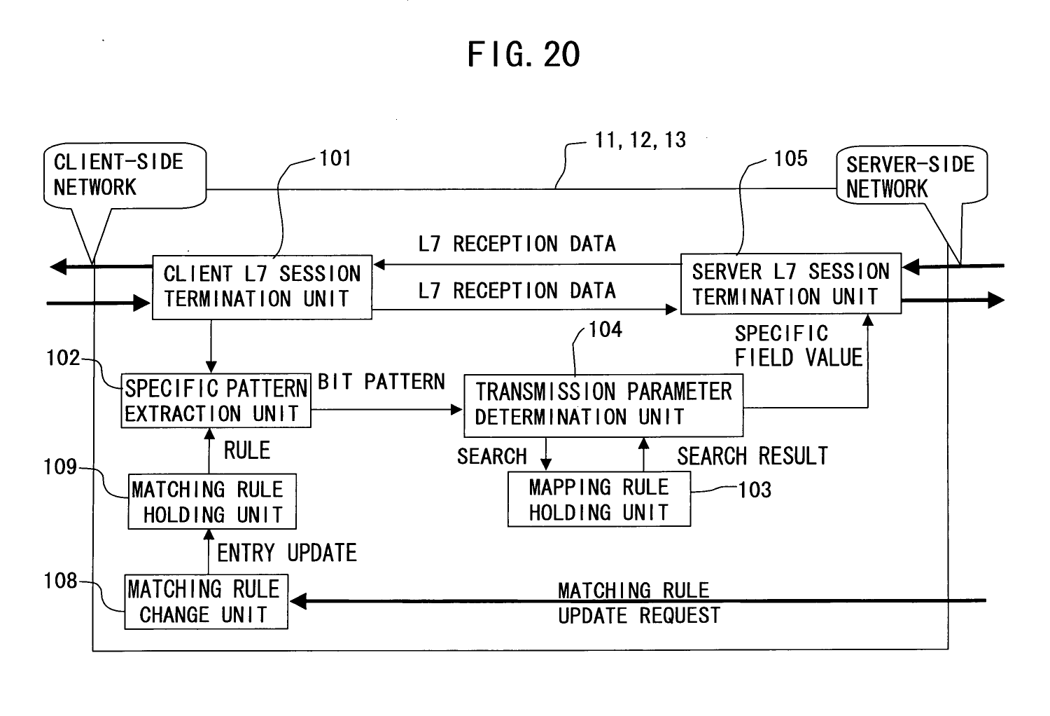

FIG. 20 shows a functional configuration of the preceding apparatuses in the second modification.

The matching rule holding unit 109 holds a matching rule for matching by the specific pattern extraction unit 102. That is, the specific pattern extraction unit 102 extracts a specific field value using the matching rule held by the matching rule holding unit 109.

The matching rule change unit 108 accepts a request to update the rule applied to the matching in the specific pattern extraction and changes the contents of the matching rule holding unit 109. Following this, the specific pattern extraction unit 102 extracts a specific field value (port number) based on the updated information in the matching rule holding unit 109.

<Operation Example in the Second Modification>

An operation of the load balancing system in the second modification in the case where a rule “Cookie: server=“server ID”” is added from a terminal outside the system under a state where no matching rule is set in the matching rule holding unit 109 will be described below.

The terminal outside the system transmits a frame, in which data indicating a new matching rule “Cookie: server=“server ID”” is set, to each of the preceding apparatuses 11 to 13. Note that the function may be implemented in the preceding apparatuses 11 to 13 or the succeeding apparatus 30 in place of the terminal outside the system.

On receiving the frame described above, the matching rule change unit 108 of the preceding apparatuses 11 to 13 stores the data “Cookie: server=“server ID”” in the matching rule holding unit 109.

As a result, it becomes possible for the specific pattern extraction unit 102 to perform bit pattern extraction using the matching rule “Cookie: server=“server ID””.

<Operation and Effect of the Second Modification>

In the load balancing system in the second modification, a rule used by the specific pattern extraction unit 102 to make a judgment for specific bit pattern extraction is changed by the matching rule change unit 108 of the preceding apparatuses 11 to 13.

As a result, it becomes possible to change a specific pattern of L7 data that should be extracted. In addition, it becomes possible to create and set multiple extraction rules. Consequently, the load balancing system in the second modification enables flexible load distribution rule application and highly advanced load distribution.

[Third Modification]

In the embodiments of the present invention, the server L7 session termination unit 105 of the preceding apparatus makes a setting for one field (source port number, for instance). Consequently, the specific field extraction unit 131 of the succeeding apparatus performs extraction from one specific field and the L7 distribution destination determination unit 133 performs distribution destination determination using one field.

In the present invention, however, multiple specific fields may be used in order to determine the distribution destination. In this case, for instance, information that will become a distribution destination determination factor is set in the multiple specific fields by the server L7 session termination unit 105 of the preceding apparatus, the information set in the multiple fields is extracted by the specific field extraction unit 131 of the succeeding apparatus, and the L7 distribution destination determination unit 133 determines the distribution destination server based on the information set in the multiple fields.

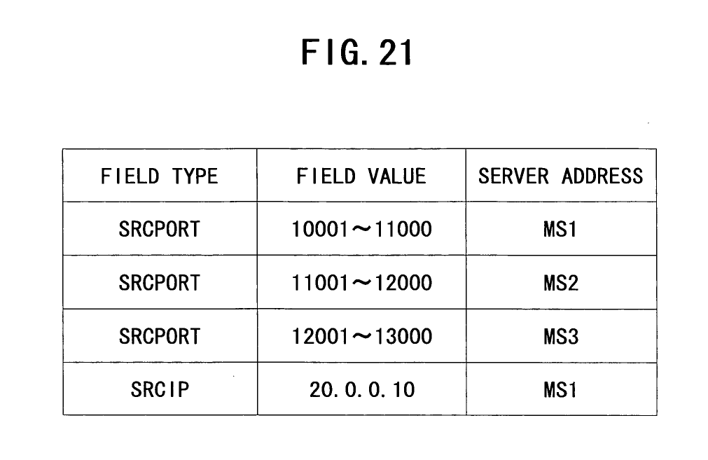

A modification of the distribution rule table possessed by the L7 distribution rule holding unit 132 in this case is shown in FIG. 21. The distribution rule table shown in FIG. 21 provides a definition where when “10001 to 11000” is set in the source port field (field type: SrcPort) or “20. 0. 0. 10” is set in the source IP address field (field type: SrcIP), “MS1” is selected as the distribution destination server. That is, any of the source port number and the source IP address is used to determine the distribution destination server.

<Operation and Effect of the Third Modification>

In the load balancing system in the third modification, it becomes possible for the succeeding apparatus 30 to make a distribution judgment using multiple specific fields. As a result, the load balancing system in the third modification enables a highly advanced load distribution.

<Others>

The disclosures of Japanese patent application No. JP2004-367864 filed on Dec. 20, 2004 including the specification, drawings and abstract are incorporated herein by reference.

What is claimed is:

1. A relay system relaying communication data transmitted from a client when the client requests provision of an application to one of one or more servers in a network, the network being formed by the one or more servers having the same application and the client, the communication data being exchanged between the client and the one or more servers by being divided into one or more frames, the relay system including
a preceding apparatus connected to the client and
a succeeding apparatus connected to the one or more servers,
the preceding apparatus comprising:
an obtainment unit obtaining the communication data from the one or more frames transmitted from the client;
an extraction unit extracting predetermined data from the obtained communication data;
a determination unit determining predetermined field data corresponding to the predetermined data; and
a transmission unit setting the predetermined field data in the one or more frames and transmitting the set one or more frames,
the succeeding apparatus comprising:
a succeeding extraction unit receiving the one or more frames transmitted from the preceding apparatus and extracting the predetermined field data from the received one or more frames;
a relay destination determination unit determining a relay destination server corresponding to the extracted predetermined field data from among the one or more servers connected to the succeeding apparatus; and
a transmission destination change unit changing a destination of the one or more frames received from the preceding apparatus to an address of the determined relay destination server and transmitting the changed one or more frames.

2. A relay system according to claim 1, wherein the determination unit determines predetermined second field data in a case where it is impossible to extract the predetermined data from the obtained communication data, and
the relay destination determination unit determines a relay destination server under a predetermined rule from among the one or more servers connected to the succeeding apparatus when judging that the extracted predetermined field data is the predetermined second field data.

3. A relay system according to claim 1, the succeeding apparatus further comprising
a transfer unit transferring the received one or more frames to the preceding apparatus when the received one or more frames are not frames transmitted from the preceding apparatus.

4. A relay system according to claim 1, the relay system including a plurality of succeeding apparatuses,
the preceding apparatus further comprising
a succeeding selection unit selecting a succeeding apparatus serving as a transfer destination from among the plurality of succeeding apparatuses based on the predetermined data extracted by the extraction unit,
wherein the transmission unit sets the predetermined field data in the one or more frames, changes a destination of the one or more frames to an address of the selected succeeding apparatus, and transmits the changed one or more frames.

5. A relay system according to claim 1,
the preceding apparatus further comprising:
a correspondence table holding unit holding a correspondence table showing correspondence between the predetermined data and the predetermined field data, the correspondence table being referred by the determination unit when determining the predetermined field data; and
a correspondence table change unit changing contents of the correspondence table.

6. A relay system according to claim 1,
the preceding apparatus further comprising:
an extraction rule holding unit holding an extraction rule, the extraction rule being for extracting the predetermined data from the communication data and being referred to by the extraction unit when extracting the predetermined data; and
a rule change unit changing contents of the extraction rule.

7. A relay system according to claim 1, wherein
the determination unit determines a plurality of pieces of predetermined field data corresponding to the predetermined data,
the transmission unit sets the plurality of pieces of predetermined field data in the one or more frames and transmits the set one or more frames,
the succeeding extraction unit extracts the plurality of pieces of predetermined field data from the received one or more frames, and
the relay destination determination unit determines a relay destination server corresponding to the extracted plurality of pieces of predetermined field data from among the one or more servers connected to the succeeding apparatus.

8. A relay method relaying communication data transmitted from a client when the client requests provision of an application to one of one or more servers in a network, the network being formed by the one or more servers having the same application and the client, the communication data being exchanged between the client and the one or more servers by being divided into one or more frames,
preceding steps done by an apparatus connected to the client, the preceding steps comprising the steps of:
obtaining the communication data from the one or more frames transmitted from the client;
extracting predetermined data from the obtained communication data;
determining predetermined field data corresponding to the predetermined data;
setting the predetermined field data in the one or more frames; and
transmitting the set one or more frames,
succeeding steps done by an apparatus connected to the one or more servers, the succeeding steps comprising the steps of:
receiving the one or more frames transmitted from the preceding apparatus and extracting the predetermined field data from the received one or more frames;
determining a relay destination server corresponding to the extracted predetermined field data from among the one or more servers connected to the succeeding apparatus;
changing a destination of the one or more frames received from the preceding apparatus to an address of the determined relay destination server; and
transmitting the changed one or more frames.
